(19) United States
(12) Patent Application Publication
(10) Pub. No.: US 2025/0251872 A1
(43) Pub. Date: Aug. 7, 2025

(54) ELECTRONIC APPARATUS AND CONTROLLING METHOD THEREOF

(71) Applicant: Samsung Electronics Co., Ltd., Suwon-si (KR)

(72) Inventors: Jinwoo AHN, Suwon-si (KR); Kwangil PARK, Suwon-si (KR); Hyeonsik SEO, Suwon-si (KR); Woojei CHOI, Suwon-si (KR)

(21) Appl. No.: 18/968,467

(22) Filed: Dec. 4, 2024

Related U.S. Application Data
(63) Continuation of application No. PCT/KR2024/017569, filed on Nov. 8, 2024.

(30) Foreign Application Priority Data
Feb. 1, 2024 (KR) 10-2024-0015942

(51) Int. Cl. G06F 3/06

(52) U.S. Cl. CPC G06F 3/0644; G06F 3/0608; G06F 3/0641

(57) ABSTRACT

An electronic apparatus that manages training data of an artificial intelligence model, and a controlling method thereof are provided. The electronic apparatus includes memory storing one or more computer programs and configured to map first identification information of a first artificial intelligence model and first version information including key values indicating storage locations of files included in a first training data set used in training of the first artificial intelligence model, and store the information, and one or more processors communicatively coupled to the memory, wherein the one or more computer programs include computer-executable instructions that, when executed by the one or more processors individually or collectively, cause the electronic apparatus to obtain second identification information of a second artificial intelligence model updated from the first artificial intelligence model and hash information of a second training data set used in training of the second artificial intelligence model, generate key values indicating storage locations of files included in the second training data set based on the hash information, identify the generated key values as a first type indicating a new file or a second type indicating a duplicate file by comparing the key values included in the first version information and the generated key values, or identify the key values included in the first version information as a third type indicating a deleted file, generate second version information including at least one type among the first type, the second type, or the third type, and key values corresponding to the at least one type, map the second version information and the second identification information of the second artificial intelligence model, and store the information in the memory, based on receiving a control command requesting a training data set of the second artificial intelligence model, identify a location wherein the second training data set is stored based on at least one of the first version information or the second version information, and provide address information of files included in the second training data set.

### CROSS-REFERENCE TO RELATED APPLICATION(S)

This application is a continuation application, claiming priority under § 365 (c), of an International application No. PCT/KR2024/017569, filed on Nov. 8, 2024, which is based on and claims the benefit of a Korean patent application number 10-2024-0015942, filed on Feb. 1, 2024, in the Korean Intellectual Property Office, the disclosure of which is incorporated by reference herein in its entirety.

### BACKGROUND OF THE INVENTION

### Field of the Invention

The disclosure relates to an electronic apparatus and a controlling method thereof. More particularly, the disclosure relates to an electronic apparatus that manages training data of an artificial intelligence model, and a controlling method thereof.

### Description of the Related Art

Data of a large scale may be used in training and utilizing an artificial intelligence model. More particularly, a generative artificial intelligence model uses more data sets than a general artificial intelligence model. For managing data of a large scale, a packaging (or grouping) method is used. A packaging method may be a method of dividing data in a predetermined unit (package) and storing the data. For managing data of a large scale, data may be loaded (or called) in parallel.

In management of data of a large scale, there is a problem that the relation between a data list and files stored by a packaging method becomes more and more complex. There is a growing possibility that a management system of the related art which manages data in file units would have a slow processing speed or could not be used.

As an example, a file system that backs up training data of each version separately may have an advantage that rollback is possible even if the original data is corrected or deleted. However, as such a file system has a very slow processing speed, there is a problem that it is not appropriate for processing data of a large scale.

As an example, a file system that does not back up files themselves but independently stores only keys of the files may have an advantage that the storage space is reduced in management of data of a small scale as it stores only the keys. However, such a file system has a problem that, as the physical relation among files of training data becomes complex in management of data of a large scale, a great amount of processing capacity is needed and the processing speed becomes slow.

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Solution

Aspects of the disclosure are to address at least the above-mentioned problems and/or disadvantages and to provide at least the advantages described below. Accordingly, an aspect of the disclosure is to provide an electronic apparatus that controls the number of times of storing duplicate files to the minimum by managing a use history of training data, and a controlling method thereof.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes memory storing one or more computer programs and configured to map first identification information of a first artificial intelligence model and first version information including key values indicating storage locations of files included in a first training data set used in training of the first artificial intelligence model, and store the information, and one or more processors communicatively coupled to the memory, wherein the one or more computer programs include computer-executable instructions that, when executed by the one or more processors individually or collectively, cause the electronic apparatus to obtain second identification information of a second artificial intelligence model updated from the first artificial intelligence model and hash information of a second training data set used in training of the second artificial intelligence model, generate key values indicating storage locations of files included in the second training data set based on the hash information, identify the generated key values as a first type indicating a new file or a second type indicating a duplicate file by comparing the key values included in the first version information and the generated key values, or identify the key values included in the first version information as a third type indicating a deleted file, generate second version information including at least one type among the first type, the second type, or the third type, and key values corresponding to the at least one type, map the second version information and the second identification information of the second artificial intelligence model, and store the information in the memory, based on receiving a control command requesting a training data set of the second artificial intelligence model, identify a location wherein the second training data set is stored based on at least one of the first version information or the second version information, and provide address information of files included in the second training data set.

The one or more computer programs further include computer-executable instructions that, when executed by the one or more processors individually or collectively, cause the electronic apparatus to, based on the generated key values not being included in a current cache, store the generated key values in an additional cache, and based on the generated key values being included in the current cache, delete the generated key values from the latest cache and store the generated key values in a duplicate cache.

The one or more computer programs further include computer-executable instructions that, when executed by the one or more processors individually or collectively, cause the electronic apparatus to, based on key values being included in the additional cache, identify the key values included in the additional cache as the first type.

The one or more computer programs further include computer-executable instructions that, when executed by the one or more processors individually or collectively, cause the electronic apparatus to obtain a first number of the key values included in the duplicate cache, obtain a second number of the key values that were not deleted in the latest cache, identify the second type or the third type by comparing the first number and the second number, and generate the second version information including the key values corresponding to the second type or the third type.

The first number indicates the number of files that are included in both of the first training data set and the second training data set, and the second number indicates the number of files that are included in the first training data set but are not included in the second training data set.

The one or more computer programs further include computer-executable instructions that, when executed by the one or more processors individually or collectively, cause the electronic apparatus to, based on the second number not being smaller than the first number, identify the key values included in the duplicate cache as the second type, and generate the second version information including the second type and the key values corresponding to the second type.

The one or more computer programs further include computer-executable instructions that, when executed by the one or more processors individually or collectively, cause the electronic apparatus to, based on the second number being smaller than the first number, identify the key values that were not deleted in the latest cache as the third type, and generate the second version information including the third type and the key values corresponding to the third type.

The one or more computer programs further include computer-executable instructions that, when executed by the one or more processors individually or collectively, cause the electronic apparatus to, based on the second version information being generated, delete the key values included in the latest cache, and store the key values included in at least one of the additional cache or the duplicate cache in the latest cache.

The hash information includes at least one of the names of the files included in the second training data set or the hash values of the files included in the second training data set, and the one or more computer programs further include computer-executable instructions that, when executed by the one or more processors individually or collectively, cause the electronic apparatus to generate the key values of the files included in the second training data set based on at least one of the names or the hash values.

The one or more computer programs further include computer-executable instructions that, when executed by the one or more processors individually or collectively, cause the electronic apparatus to, based on at least one of the names or the hash values, obtain identification information of a data package wherein the files included in the second training data set are included and information on physical locations wherein the files included in the second training data set are stored in the data package, and generate the key values of the files included in the second training data set by combining the identification information of the data package and the physical location information.

In accordance with another aspect of the disclosure, a method of controlling an electronic apparatus is provided. The method includes mapping first identification information of a first artificial intelligence model and first version information including key values indicating storage locations of files included in a first training data set used in training of the first artificial intelligence model, and storing the information, obtaining second identification information of a second artificial intelligence model updated from the first artificial intelligence model and hash information of a second training data set used in training of the second artificial intelligence model, generating key values indicating storage locations of files included in the second training data set based on the hash information, identifying the generated key values as a first type indicating a new file or a second type indicating a duplicate file by comparing the key values included in the first version information and the generated key values, or identifying the key values included in the first version information as a third type indicating a deleted file, generating second version information including at least one type among the first type, the second type, or the third type, and key values corresponding to the at least one type, mapping the second version information and the second identification information of the second artificial intelligence model, and storing the information in the electronic apparatus, based on receiving a control command requesting a training data set of the second artificial intelligence model, identifying a location wherein the second training data set is stored based on at least one of the first version information or the second version information, and providing address information of files included in the second training data set.

The method includes, based on the generated key values not being included in a current cache, storing the generated key values in an additional cache, and based on the generated key values being included in the current cache, deleting the generated key values from the latest cache and storing the generated key values in a duplicate cache.

The method includes, based on key values being included in the additional cache, identifying the key values included in the additional cache as the first type.

The method includes obtaining a first number of the key values included in the duplicate cache, obtaining a second number of the key values that were not deleted in the latest cache, and identifying the second type or the third type by comparing the first number and the second number, and the generating of the second version information, the second version information including the key values corresponding to the second type or the third type is generated.

The first number indicates the number of files that are included in both of the first training data set and the second training data set, and the second number indicates the number of files that are included in the first training data set but are not included in the second training data set.

The method includes, based on the second number not being smaller than the first number, identifying the key values included in the duplicate cache as the second type, and in the generating of the second version information, the second version information including the second type and the key values corresponding to the second type is generated.

The method includes, based on the second number being smaller than the first number, identifying the key values that were not deleted in the latest cache as the third type, and in the generating of the second version information, the second version information including the third type and the key values corresponding to the third type is generated.

The method includes, based on the second version information being generated, deleting the key values included in the latest cache, and storing the key values included in at least one of the additional cache or the duplicate cache in the latest cache.

The hash information includes at least one of the names of the files included in the second training data set or the hash values of the files included in the second training data set, and in the generating of the key values, the key values of the files included in the second training data set is generated based on at least one of the names or the hash values.

In the generating of the key values, based on at least one of the names or the hash values, identification information of a data package wherein the files included in the second training data set are included and information on physical locations wherein the files included in the second training data set are stored in the data package is obtained, and the key values of the files included in the second training data set is generated by combining the identification information of the data package and the physical location information.

In accordance with another aspect of the disclosure, one or more non-transitory computer-readable storage media storing computer-executable instructions that, when executed by one or more processors individually or collectively, cause an electronic apparatus to perform operations are provided. The operations include mapping first identification information of a first artificial intelligence model, and first version information including key values indicating storage locations of files included in a first training data set used in training of the first artificial intelligence model, and storing the information, obtaining second identification information of a second artificial intelligence model updated from the first artificial intelligence model and hash information of a second training data set used in training of the second artificial intelligence model, generating key values indicating storage locations of files included in the second training data set based on the hash information, identifying the generated key values as a first type indicating a new file or a second type indicating a duplicate file by comparing the key values included in the first version information and the generated key values, or identifying the key values included in the first version information as a third type indicating a deleted file, generating second version information including at least one type among the first type, the second type, or the third type, and key values corresponding to the at least one type, mapping the second version information and the second identification information of the second artificial intelligence model, and storing the information in the electronic apparatus, based on receiving a control command requesting a training data set of the second artificial intelligence model, identifying a location wherein the second training data set is stored based on at least one of the first version information or the second version information, and providing address information of files included in the second training data set.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for illustrating an artificial intelligence model and a training process of an artificial intelligence model according to an embodiment of the disclosure;

FIG. 2 is a block diagram illustrating an electronic apparatus according to an embodiment of the disclosure;

FIG. 3 is a block diagram for illustrating an operation of updating version information of training data according to an embodiment of the disclosure;

FIG. 4 is a diagram for illustrating an operation of storing key values in a cache in an updating operation of training data according to an embodiment of the disclosure;

FIG. 5 is a diagram for illustrating an operation of updating version information of training data based on key values stored in a cache according to an embodiment of the disclosure;

FIG. 6 is a diagram for illustrating an operation of providing address information of files included in a training data set according to an embodiment of the disclosure;

FIG. 7 is a diagram for illustrating a relation between an artificial intelligence server and a data server according to an embodiment of the disclosure;

FIG. 8 is a diagram for illustrating a data set, hash information, key values, or the like, according to an embodiment of the disclosure;

FIG. 9 is a diagram for illustrating an operation of generating key values according to an embodiment of the disclosure;

FIG. 10 is a diagram for illustrating an operation of generating version information according to a training process according to an embodiment of the disclosure;

FIG. 11 is a diagram for illustrating an operation of generating version information according to a training process according to an embodiment of the disclosure;

FIG. 12 is a diagram for illustrating an operation of generating version information according to a training process according to an embodiment of the disclosure;

FIG. 13 is a diagram for illustrating an operation of generating version information according to a training process according to an embodiment of the disclosure;

FIG. 14 is a diagram for illustrating an operation of generating version information according to a training process according to an embodiment of the disclosure;

FIG. 15 is a diagram for illustrating a plurality of training processes according to an embodiment of the disclosure;

FIG. 16 is a diagram for illustrating an operation of generating key values according to an embodiment of the disclosure;

FIG. 17 is a diagram for illustrating an operation of controlling a cache according to an embodiment of the disclosure;

FIG. 18 is a diagram for illustrating an operation of generating version information according to an embodiment of the disclosure;

FIG. 19 is a diagram for illustrating an operation of identifying files included in training data according to an embodiment of the disclosure;

FIG. 20 is a diagram for illustrating an operation of comparing key values according to an embodiment of the disclosure;

FIG. 21 is a diagram for illustrating an operation of managing training data according to an embodiment of the disclosure;

FIG. 22 is a diagram for illustrating an operation of identifying key values of files used in a training process based on the stored version information according to an embodiment of the disclosure;

FIG. 23 is a diagram for illustrating a training process of an artificial intelligence model according to an embodiment of the disclosure; and

FIG. 24 is a diagram for illustrating a method of controlling an electronic apparatus according to an embodiment of the disclosure.

Throughout the drawings, it should be noted that like reference numbers are used to depict the same or similar elements, features, and structures.

### MODE FOR IMPLEMENTING THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As terms used in the embodiments of the disclosure, general terms that are currently used widely were selected as far as possible, based on the functions described in the disclosure. However, the terms may vary depending on the intention of those skilled in the art, previous court decisions, or emergence of new technologies, or the like. In addition, in particular cases, there may be terms that were arbitrarily designated by the applicant, and in such cases, the meaning of the terms will be described in the relevant descriptions in the disclosure. Accordingly, the terms used in the disclosure should be defined based on the meaning of the terms and the overall content of the disclosure, but not just based on the names of the terms.

In addition, in this specification, expressions, such as “have,” “may have,” “include,” and “may include” denote the existence of such characteristics (e.g., elements, such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. In addition, such expressions are used only to distinguish one element from another element, and are not intended to limit the elements.

Meanwhile, the description in the disclosure that one element (e.g., a first element) is “(operatively or communicatively) coupled with/to” or “connected to” another element (e.g., a second element) should be interpreted to include both the case where the one element is directly coupled to the another element, and the case where the one element is coupled to the another element through still another element (e.g., a third element).

Further, in the disclosure, terms, such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, “a module” or “a part” performs at least one function or operation, and may be implemented as hardware or software, or as a combination of hardware and software. In addition, a plurality of “modules” or “parts” may be integrated into at least one module and implemented as at least one processor (not shown), except “a module” or “a part” that needs to be implemented as specific hardware.

Further, in this specification, the term “user” may refer to a person who uses an electronic apparatus or an apparatus using an electronic apparatus (e.g., an artificial intelligence electronic apparatus).

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Hereinafter, an embodiment of the disclosure will be described with reference to the accompanying drawings.

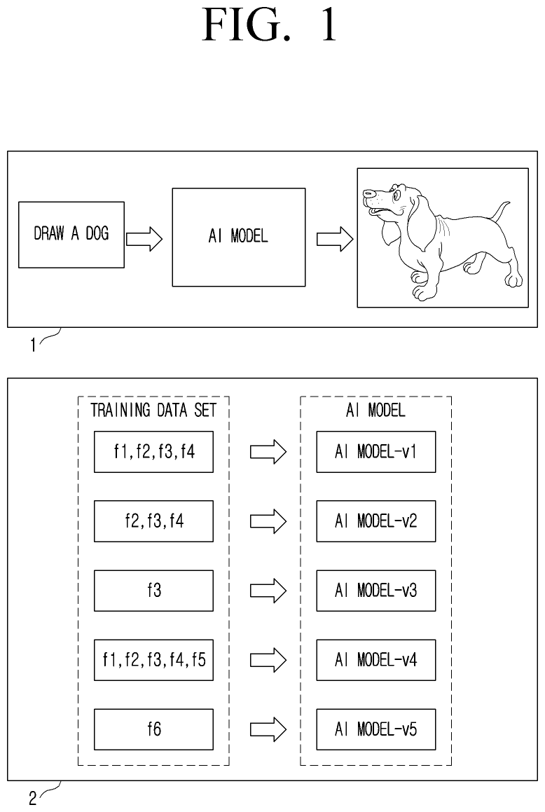

FIG. 1 is a diagram for illustrating an artificial intelligence model and a training process of an artificial intelligence model according to an embodiment of the disclosure.

Referring to FIG. 1, an artificial intelligence model may be a model that generates (or provides or obtains) output data correspondingly to input data. The artificial intelligence model may be updated through a training process. The update may include a generating process and a changing process. The artificial intelligence model may be trained based on training data. The training data may be information used for the artificial intelligence model to be trained to generate output data corresponding to input data. The training data may also be described as training data set as it includes a plurality of information.

Referring to the embodiment 1 in FIG. 1, the artificial intelligence model may be a generative artificial intelligence model. A generative artificial intelligence model may mean an artificial intelligence technology enabling generation of new data correspondingly to input data.

Input data may be one of a text, an image, or audio. Output data may be one of a new text, a new image, or new audio. New data may mean data having similar characteristics to those of input data. In addition, new data may indicate data that was newly created by the artificial intelligence model, but not data that searched the existing data.

For example, input data may be a text or audio which is “Draw a dog.” Output data generated by the artificial intelligence model may be a generated dog image. The generated dog image may not be a searched image, but new data that was generated based on “Draw a dog.”

Referring to the embodiment 2 in FIG. 1, the artificial intelligence model may be updated through a plurality of training processes. Whenever a training process is performed, a training data set may be changed.

The first artificial intelligence model v1 may be a model that was obtained through the first training process. In addition, the first artificial intelligence model v1 may be a model that was trained by the first training data set. The first training data set may include at least one file f1, f2, f3, f4.

The second artificial intelligence model v2 may be a model that was obtained through the second training process. In addition, the second artificial intelligence model v2 may be a model that was trained by the second training data set. The second training data set may include at least one file f2, f3, f4. Unlike in the first training process, some files (f1) may not be used in the second training process.

The third artificial intelligence model v3 may be a model that was obtained through the third training process. In addition, the third artificial intelligence model v3 may be a model that was trained by the third training data set. The third training data set may include at least one file f3. Unlike in the second training process, some files (f2, f4) may not be used in the third training process.

The fourth artificial intelligence model v4 may be a model that was obtained through the fourth training process. In addition, the fourth artificial intelligence model v4 may be a model that was trained by the fourth training data set. The fourth training data set may include at least one file f1, f2, f3, f4, f5. Unlike in the third training process, some files (f1, f2, f4, f5) may be additionally used in the fourth training process.

The fifth artificial intelligence model v5 may be a model that was obtained through the fifth training process. In addition, the fifth artificial intelligence model v5 may be a model that was trained by the fifth training data set. The fifth training data set may include at least one file f6. Unlike in the fourth training process, all of the existing files f1, f2, f3, f4, f5 may not be used, but a new file (f6) may be used in the fifth training process.

As files used in each training process are changed, an operation of storing and managing the training data sets may vary. Although the files used in the training processes are changed, there may be some duplicate files. The data management efficiency may vary according to methods of managing duplicate files.

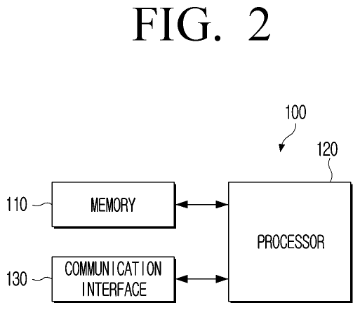

An embodiment of providing training data for a trained artificial intelligence model will be explained in FIG. 2.

FIG. 2 is a block diagram illustrating an electronic apparatus according to an embodiment of the disclosure.

Referring to FIG. 2, an electronic apparatus 100 may include at least one of memory 110, a processor 120, or a communication interface 130.

The electronic apparatus 100 may be an apparatus that provides information related to an artificial intelligence model. In addition, the electronic apparatus 100 may be an apparatus that uses a trained artificial intelligence model, and an apparatus that provides training data for a trained artificial intelligence model.

The memory 110 may be implemented as internal memory, such as read-only memory (ROM) (e.g., electrically erasable programmable read-only memory (EEPROM)), random access memory (RAM), or the like, included in the at least one processor 120, or implemented as separate memory from the at least one processor 120. In this case, the memory 110 may be implemented in the form of memory embedded in the electronic apparatus 100, or implemented in the form of memory that can be attached to or detached from the electronic apparatus 100 according to the use of stored data. For example, in the case of data for driving the electronic apparatus 100, the data may be stored in memory embedded in the electronic apparatus 100, and in the case of data for an extended function of the electronic apparatus 100, the data may be stored in memory that can be attached to or detached from the electronic apparatus 100.

The memory 110 may store at least one instruction. The at least one processor 120 may perform various operations based on the instructions stored in the memory 110.

The at least one processor 120 may be implemented as a digital signal processor (DSP) processing digital signals, a microprocessor, and a time controller (TCON). However, the disclosure is not limited thereto, and the at least one processor 120 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. In addition, the at least one processor 120 may be implemented as a system on chip (SoC) having a processing algorithm stored therein or large scale integration (LSI), or implemented in the form of a field programmable gate array (FPGA). The at least one processor 120 may perform various functions by executing computer executable instructions stored in the memory.

The communication interface 130 is a component that performs communication with various types of external apparatuses according to various types of communication methods. The communication interface 130 may include a wireless communication module or a wired communication module. Each communication module may be implemented in the form of at least one hardware chip.

The electronic apparatus 100 may include memory 110 that maps first identification information of a first artificial intelligence model and first version information including key values indicating storage locations of files included in a first training data set used in training of the first artificial intelligence model, and stores the information, and a processor 120 that is connected with the memory 110 and controls the electronic apparatus 100.

The first artificial intelligence model v1 may be a model that was obtained through the first training process.

The first identification information may be information for specifying the first artificial intelligence model. The first identification information of the first artificial intelligence model may include at least one of the name, the number, the service name, or the trademark of the first artificial intelligence model.

The first training data set may indicate a data group including at least one information used in training of the first artificial intelligence model.

The key values may indicate values indicating locations (or addresses) wherein specific files are stored. The key values may be used in an operation of calling (or extracting) specific files. The key values may be generated based on a predetermined format. The expression key values may be a description including the singular and the plural.

The first version information may be information indicating whether specific files were used in the training process of the first artificial intelligence model.

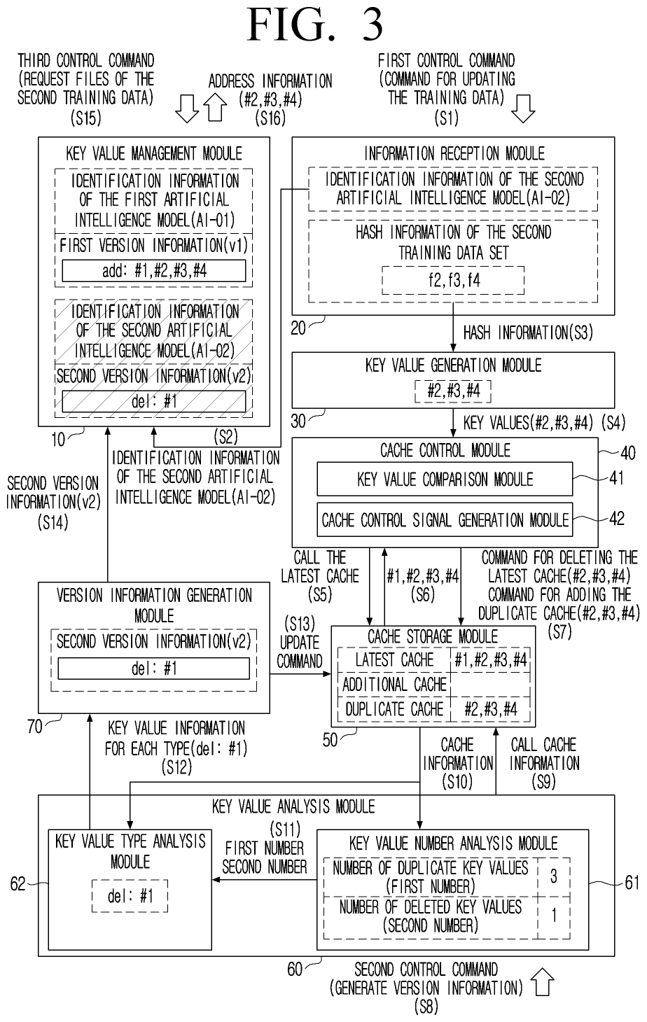

Detailed explanation regarding the first artificial intelligence model, the first identification information, the first training data set, the key values, the first version information, or the like, will be described in FIG. 3.

The processor 120 may obtain second identification information of a second artificial intelligence model updated from the first artificial intelligence model and hash information of a second training data set used in training of the second artificial intelligence model. The processor 120 may generate key values indicating storage locations of files included in the second training data set based on the hash information.

The second artificial intelligence model may be a model that performed an additional learning operation regarding the first artificial intelligence model. In addition, the second artificial intelligence model may be an updated first artificial intelligence model.

The second identification information may be information for specifying the second artificial intelligence model. The second identification information of the second artificial intelligence model may include at least one of the name, the number, the service name, or the trademark of the second artificial intelligence model.

The second training data set may indicate a data group including at least one information used in training of the second artificial intelligence model.

The hash information may include information indicating a storage location of at least one file included in a training data set. The hash information may include values converted by using a hash function, or the like, for indicating specific data.

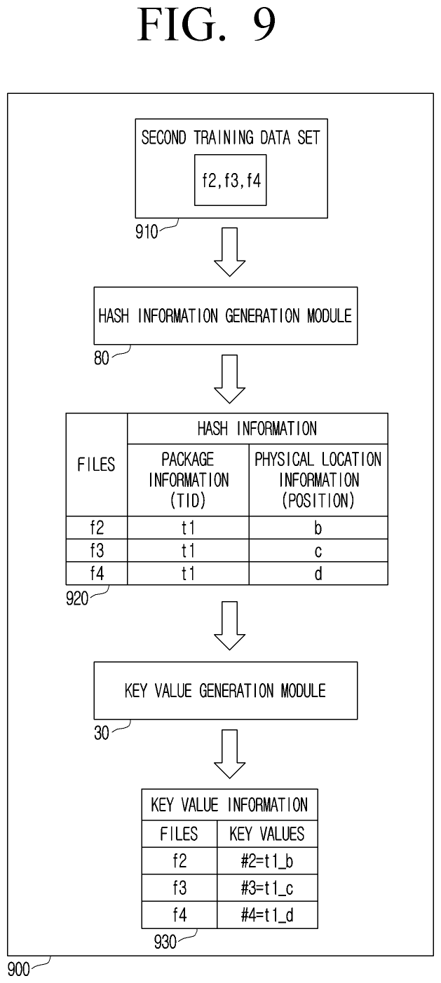

Detailed explanation regarding the second artificial intelligence model, the second identification information, the second training data set, the hash information, or the like, will be described in FIG. 3. A detailed calculation process of generating key values will be described in FIG. 9.

The processor 120 may identify types for key values. The key values which are subjects for identifying types may include key values that were newly generated and key values that were used in the previous training process. The processor 120 may identify types (or type information) corresponding to key values by a predetermined method.

The processor 120 may identify the generated key values as a first type indicating a new file or a second type indicating a duplicate file by comparing the key values included in the first version information and the generated key values, or identify the key values included in the first version information as a third type indicating a deleted file.

The first type may indicate added key values. The first type may indicate that a specific key value (a specific file) is a key value (a file) that was not used in the previous training operation. The first type may also be described as an add (additional) type.

The second type may indicate duplicate key values. The second type may indicate that a specific key value (a specific file) is a key value (a file) that was used in the previous training operation. The second type may also be described as a dup (duplicate) type.

The third type may indicate deleted key values. The third type may indicate that a specific key value (a specific file) is a key value (a file) that was used in the previous training operation, but is not used in the current (the next) training operation. The third type may also be described as a del (deleted) type.

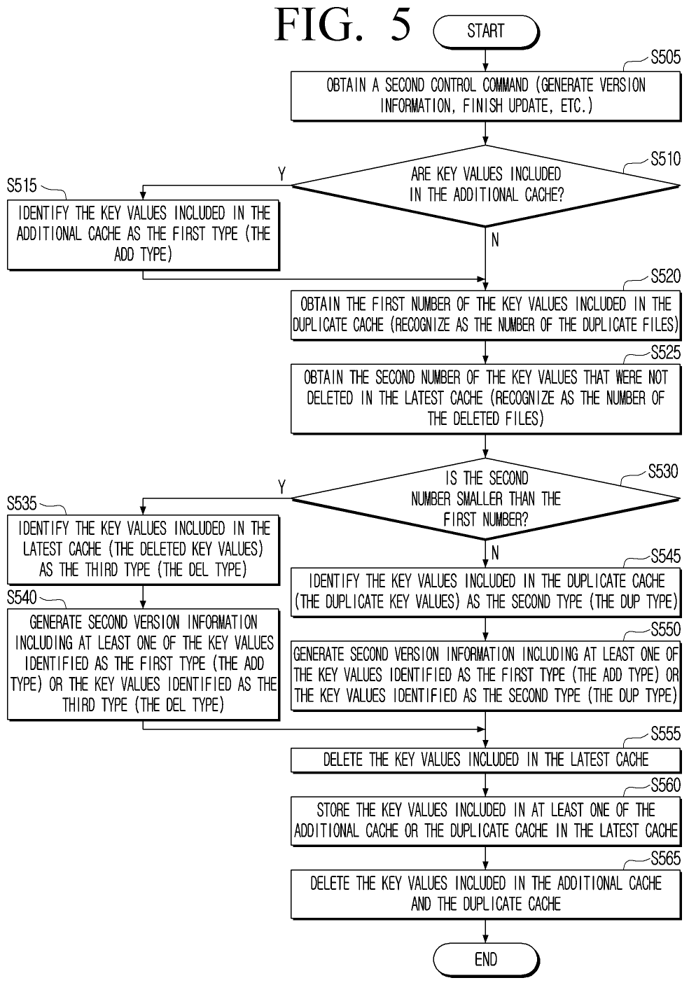

The operation of identifying types will be additionally explained through a key value type analysis module 62 in FIG. 3, and the operations S515, S535, S545 in FIG. 5, or the like.

The processor 120 may generate second version information including at least one type among the first type, the second type, or the third type, and key values corresponding to the at least one type, and map the second version information and the second identification information of the second artificial intelligence model, and store the information in the memory 110.

The second version information may be information indicating whether specific files were used in the training process of the second artificial intelligence model. The operation of generating the second version information will be additionally explained through a version information generation module 70 in FIG. 3. The operation of mapping the second version information and the second identification information of the second artificial intelligence model, and storing the information in the memory 110 will be additionally explained through an operation of a key value management module 10 of storing the second version information v2 and the second identification information AI-02 of the second artificial intelligence model.

If a control command (a third control command in FIG. 3) requesting a training data set of the second artificial intelligence model is received, the processor 120 may identify the location wherein the second training data set is stored based on at least one of the first version information or the second version information, and provide address information of files included in the second training data set.

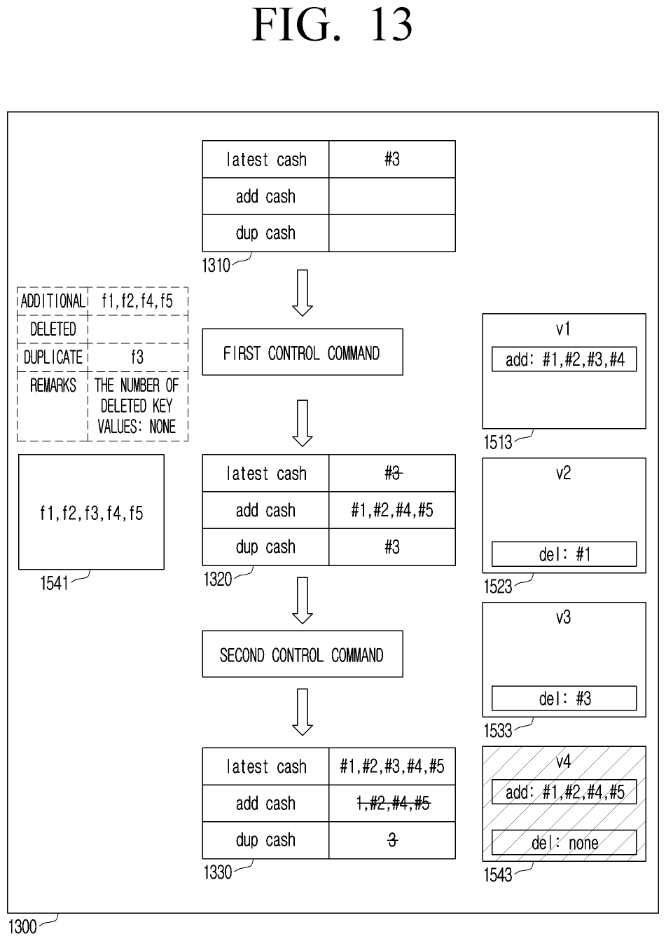

The address information may be information indicating locations wherein specific files (at least one file) are stored. The operation of providing the address information will be additionally explained through the operation S16 in FIG. 13.

If the generated key values are not included in a latest cache, the processor 120 may store the generated key values in an additional cache.

If the generated key values are included in a latest cache, the processor 120 may delete the generated key values in the latest cache, and store the generated key values in a duplicate cache.

If the key values are included in the additional cache, the processor 120 may identify the key values included in the additional cache as the first type.

The processor 120 may obtain the first number of the key values included in the duplicate cache. The first number may indicate the number of files that are included in both of the first training data set and the second training data set.

The processor 120 may obtain the second number of the key values that were not deleted in the latest cache. The second number may indicate the number of files that are included in the first training data set but are not included in the second training data set.

The processor 120 may identify the second type or the third type by comparing the first number and the second number, and generate the second version information including the key values corresponding to the second type or the third type.

The latest cache may indicate a memory area storing key values included in the training data set that was used the most recently. The key values included in the latest cache after version information was generated may be the key values of the files included in the training data set.

The additional cache may indicate a memory area storing key values that were not used in the previous training operation, but are used in the current (the next) training operation. The additional cache may be used in a process of generating version information, and as the additional cache is initialized after the version information is generated, the cache may not store any values.

The duplicate cache may indicate a memory area storing key values that were used in the previous training operation, and are also used in the current (the next) training operation. The duplicate cache may be used in a process of generating version information, and as the duplicate cache is initialized after the version information is generated, the cache may not store any values.

The operation of generating the second version information by using the latest cache, the additional cache, the duplicate cache, or the like, will be additionally explained in FIGS. 3 to 6.

If the second number is not smaller than the first number, the processor 120 may identify the key values included in the duplicate cache as the second type. The processor 120 may generate the second version information including the second type and the key values corresponding to the second type. The operation in this regard will be additionally explained in the operations S545 and S550 in FIG. 5.

If the second number is smaller than the first number, the processor 120 may identify the key values that were not deleted in the latest cache as the third type. The processor 120 may generate the second version information including the third type and the key values corresponding to the third type. The operation in this regard will be additionally explained in the operations S535 and S540 in FIG. 5.

When the second version information is generated, the processor 120 may delete the key values included in the latest cache, and store the key values included in at least one of the additional cache or the duplicate cache in the latest cache. The operation in this regard will be additionally explained in the operations S555, S560, and S565 in FIG. 5.

The hash information may include at least one of the names of the files included in the second training data set or the hash values of the files included in the second training data set. The processor 120 may generate the key values of the files included in the second training data set based on at least one of the names or the hash values.

The at least one processor 120 may, based on at least one of the names or the hash values, obtain identification information of a data package wherein the files included in the second training data set are included and information on physical locations wherein the files included in the second training data set are stored in the data package. The processor 120 may generate the key values of the files included in the second training data set by combining the identification information of the data package and the physical location information.

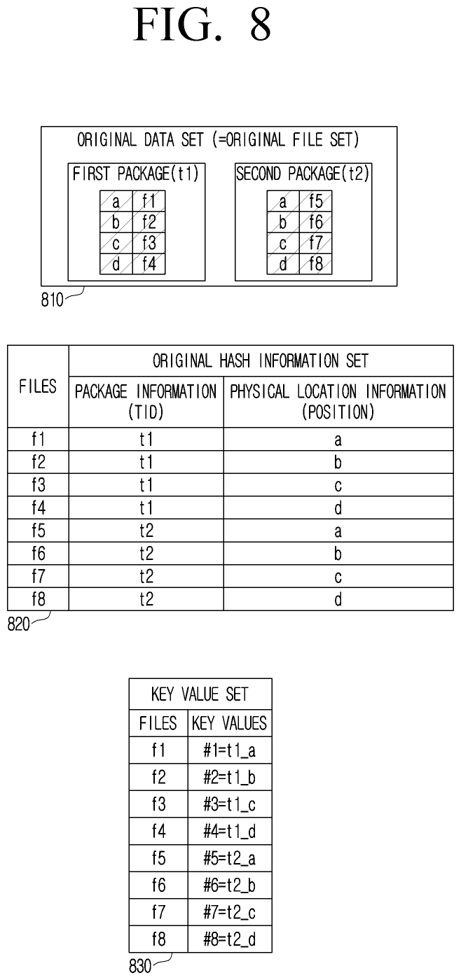

Additional explanation related to the hash information and the operation of generating the key values will be described in FIGS. 8 and 9.

The electronic apparatus 100 may effectively track and manage a training data set of a large scale used in training of an artificial intelligence model by using a packaging method. The electronic apparatus 100 may effectively manage the use history of data of a large scale used for a generative artificial intelligence model. The electronic apparatus 100 may load the data by using a real time parallel stream method. The real time parallel stream method may be a method of loading data without selectively releasing package files while training files of large scales are packaged. The electronic apparatus 100 may load only a target file (a file requested by the user) by using the version information.

The electronic apparatus 100 may effectively manage duplicate key values by using a plurality of pieces of version information. The electronic apparatus 100 may not store duplicate keys of a large scale as they are for each version information. The electronic apparatus 100 may use an optimal storage method for storing fewer key values by dividing in the second type (the dup type) or the third type (the del type). The electronic apparatus 100 may provide a key storage system by an incremental method for avoiding overconsumption of a space due to storage of duplicate key values. The space may be saved through storage by an incremental method.

The electronic apparatus 100 may obtain key values included in the address information, and obtain information on a package wherein files are stored and information on physical locations based on the key values. The electronic apparatus 100 can immediately identify a specific package wherein files are stored based on the package information and the physical location information. The electronic apparatus 100 can easily identify in which package a specific file is stored without releasing the plurality of stored packages. The electronic apparatus 100 can easily manage files without correcting the original training data set. The electronic apparatus 100 can maintain integrity for the files.

An embodiment of requesting version information and training data generated in a process of updating training data by performing training for an artificial intelligence model will be described in FIG. 3.

FIG. 3 is a block diagram for illustrating an operation of updating version information of training data according to an embodiment of the disclosure.

Referring to FIG. 3, the electronic apparatus 100 may include at least one of a key value management module 10, an information reception module 20, a key value generation module 30, a cache control module 40, a key value analysis module 60, or a version information generation module 70.

The artificial intelligence model may be trained by a training data set. The key value management module 10 may store information related to the artificial intelligence model. The information related to the artificial intelligence model may include at least one of identification information of the artificial intelligence model or information corresponding to a training data set used in training of the artificial intelligence model.

The key value management module 10 may be a module that manages key values indicating storage locations of files used in a training operation of the artificial intelligence model. The key value management module 10 may map the artificial intelligence model and version information corresponding to the artificial intelligence model, and store the mapped information (mapping result information). The files used in the training operation may be included in a training data set. The key value management module 10 may provide key values indicating the storage locations of the files used in training of the artificial intelligence model. The key value management module 10 may provide address information including the key values of the files used in training.

The key values may indicate values indicating locations (or addresses) wherein specific files are stored. The key values may be used in an operation of calling (or extracting) specific files. The key values may be generated based on a predetermined format. The expression key values may be a description including the singular and the plural. The method of generating the key values will be described in the explanation of the key value generation module 30.

The version information may be information indicating whether files were used in a training process of the artificial intelligence model. The version information may indicate a history indicating whether specific files were used in a training process through a plurality of training processes. The version information may be information indicating which files were used in a plurality of number of times of training processes by comparing with the previous version information. The version information may include information indicating that files that were not included in the previous training process were added (e.g., the first type (the add type)), information indicating that files overlapping with the previous training process were used in the same manner (e.g., the second type (the dup type)), information indicating that files were used in the previous training process but were not used in the recent training process (e.g., the third type (the del type)), or the like.

The version information may also be described as history information, use history information, use information, use state information, use state comparison information, or the like.

The version information may include key values for each type. The version information may include key values for specifying files and types of specific files (or key values) for indicating whether there is a use history.

The types of the specific files (or the key values) may indicate units for dividing use histories of the specific files in a training process. The types may indicate one of predetermined types. In addition, the types may be classification units indicating the use histories of files included in a training data set in a training process. For example, the types may be one of the first type (the add type), the second type (the dup type), or the third type (the del type).

Files (or key values) divided into the first type may indicate that the files were not included in the previous training data set. Files (or key values) divided into the second type may indicate that the files were included in the previous training data set. Files (or key values) divided into the third type may indicate that the files were included in the previous training data set, but are not included in the current training data set. The method of dividing the types will be described in the explanation regarding the key value type analysis module 61.

As an example, the version information may include types and key values corresponding to the types. For example, the first version information may include a plurality of key values #01, #02, #03, #04 divided into the first type (the add type).

The types may also be described as groups, or the like.

The key value management module 10 may map identification information of an artificial intelligence model and version information of the artificial intelligence model, and store the information. For example, it is assumed that the first training data set used in training of the first artificial intelligence model includes four files f1, f2, f3, f4. The key value management module 10 may map the identification information AI-01 indicating the first artificial intelligence model and the first version information v1 of the first training data set, and store the information.

The first training data set may include at least one file f1, f2, f3, f4. The at least one file f1, f2, f3, f4 included in the first training data set may be described as the first file group.

Identification information of an artificial intelligence model may be information for specifying the artificial intelligence model. The identification information of an artificial intelligence model may include at least one of the name, the number, the service name, or the trademark of the artificial intelligence model. For example, the first identification information of the first artificial intelligence model may be AI-01.

The key value management module 10 may generate address information including key values of files used in training of an artificial intelligence model by using version information.

The address information may be information indicating locations wherein specific files (at least one file) are stored. The address information may include key values indicating locations wherein files are stored. The version information indicates use history information of specific files in a training process, but the address information may indicate locations (or addresses) wherein specific files are stored. Specific files may be called (or requested) by using key values included in the address information. The address information may include key values. The key value management module 10 may generate the address information by using the version information.

Storage locations of files used in training of a specific artificial intelligence model may be determined through the address information. Meanwhile, storage locations of files used in training of a specific artificial intelligence model may not be determined only with one version information. This is because, as version information indicates a use history, with just one version information, the key values may be identified as the second type (the dup type) indicating that specific files were used in the previous training process but are not used in the current training process anymore. In such a case, storage locations of files used in a training process may be identified based on all of the plurality of pieces of version information. The method of generating the address information will be described in the operations S14 and S15.

The information reception module 20 may be a module that receives various types of information related to an artificial intelligence model. The information reception module 20 may receive an update command (a first control command) for a training data set used in a training process of an artificial intelligence model. The information reception module 20 may receive identification information of an artificial intelligence model. In addition, the information reception module 20 may receive hash information of a training data set. The information reception module 20 may provide (or transmit) the received identification information of an artificial intelligence model or hash information of a training data set to another module. The update command may include at least one of a command for newly adding new information or a command for changing the previously stored information.

The hash information may include information indicating storage locations of at least one file included in a training data set. The hash information may include values converted by using a hash function, or the like, for indicating specific data. The hash information may include at least one of identification information (tid) or physical location information (position) of a package. The hash information may also be described as information related to a training data set.

Both of the hash information and the address information may be information used in indicating storage locations of files. The address information may include key values generated in a predetermined format by the key value generation module 30 and a type indicating a use history in a training process. The hash information may include only information simply indicating storage locations of files.

The hash information of the training data set may also be described as hash information of files used in a training process. The hash information may include information indicating storage locations of at least one file.

The hash information may also be described as metadata.

A package may be a unit dividing files in a group. A package may indicate a data package. A data package may be a unit for dividing files. A package may also be described as a bundle or a tar. The physical location information may indicate relative storage locations in a package. The physical location information may include information specifying one area among a plurality of areas included in a package.

For example, a plurality of files may be stored while being divided into a first package and a second package. The first package may include at least one file f1, f2, f3, f4, and the second package may include at least one file f5, f6, f7, f8. Each package may be divided into areas storing files. Each package may include a first area, a second area, a third area, and a fourth area. Different files may be stored in each area of the first package. Different files may be stored in each area of the second package. An area may also be described as a location.

The information reception module 20 may receive a first control command while storing information related to the first artificial intelligence model in operation S1. The information related to the first artificial intelligence model may include identification information of the first artificial intelligence model AI-01 and first version information v1. The first control command may be a command for updating training data. After the first control command is received, the information reception module 20 may receive identification information of the second artificial intelligence model AI-02 and hash information of the second training data set used in training of the second artificial intelligence model.

The second training data set may include at least one file f2, f3, f4 used in training of the second artificial intelligence model. The at least one file f2, f3, f4 included in the second training data set may also be described as the second file group.

The information reception module 20 may receive the identification information of the second artificial intelligence model AI-02 and the hash information of the second training data set used in training of the second artificial intelligence model from an external apparatus. The external apparatus may also be described as an external server. The external apparatus may be an apparatus that performs an operation of training an artificial intelligence model. The external apparatus may transmit the identification information of the trained second artificial intelligence model AI-02 and the hash information of the second training data set used in training of the second artificial intelligence model to the information reception module 20.

The information reception module 20 may transmit the identification information of the second artificial intelligence model AI-02 to the key value management module 10 in operation S2. The information reception module 20 may transmit the hash information to the key value generation module 30 in operation S3.

The key value generation module 30 may be a module that generates key values based on a predetermined format. The key values may indicate values indicating locations (or addresses) wherein specific files are stored. The key values may be used in an operation of calling (or extracting) specific files. The key value generation module 30 may be a module that generates key values corresponding to files in a format wherein the identification information of the packages and the physical location information are combined by using the hash information. By generating the key values in the predetermined format, it is possible to call (or request) specific files through the key values.

The key value generation module 30 may obtain hash information corresponding to the second training data set. The key value generation module 30 may generate key values corresponding to the second training data set.

The key values may indicate in which package files are stored. The key values may indicate in which area files are stored among a plurality of areas included in a package.

The key value generation module 30 may generate (or obtain) key values corresponding to the second training data set based on the hash information received from the information reception module 20.

The key value generation module 30 may obtain identification information of a package wherein at least one file included in the second training data set included in the hash information is stored and physical location information.

The key value generation module 30 may generate key values #2, #3, #4 of the at least one file included in the second training data set by combining the identification information of the package and the physical location information. The key value generation module 30 may generate key values including both of the identification information of the package including the files and the physical location information of the files. The physical location information may include information for specifying an area among the plurality of storage areas existing in the package.

The key value generation module 30 may transmit the key values #2, #3, #4 to the cache control module 40 in operation S4.

The cache control module 40 may be a module that generates a cache by identifying a type indicating a use history of key values, and generating a control command corresponding to the identified type. The cache control module 40 may be a module that updates cache information based on the key values generated by the key value generation module 30.

A cache may indicate an area or a unit wherein specific data is stored. A cache does not necessarily mean a storage space corresponding to volatile memory, but it may indicate a storage space corresponding to non-volatile memory. A cache may include a latest cache (a first cache), an additional cache (a second cache), and a duplicate cache (a third cache). Each cache may also be described as a detailed cache.

The cache information may be information including the latest cache (the first cache), the additional cache (the second cache), and the duplicate cache (the third cache). According to various embodiments of the disclosure, key values may not be stored in each cache. The cache information may also be described as cache data or a cache table. The caches described in the latest cache (the first cache), the additional cache (the second cache), and the duplicate cache (the third cache) may be described as cache areas.

The cache control module 40 may include at least one of a key value comparison module 41 or a cache control signal generation module 42.

The cache control module 40 may transmit a control signal for calling (or requesting) a key value stored in the latest cache to the cache storage module 50 in operation S5.

The cache storage module 50 may be a module that stores cache information. If the control command received from the cache control module 40 is received, the cache storage module 50 may perform an operation corresponding to the control command. The control command may include at least one of a command for providing (or returning) a key value stored in a specific cache, a command for adding a key value in a specific cache, or a command for deleting a key value.

The cache storage module 50 may transmit the key values #1, #2, #3, #4 stored in the latest cache to the cache control module 40 in operation S6. The cache storage module 50 may return the values #1, #2, #3, #4 stored in the latest cache to the cache control module 40 in response to the control signal for calling (or requesting) the key values stored in the latest cache.

The key value comparison module 41 may compare the key values #1, #2, #3, #4 stored in the cache storage module 50 and the key values #2, #3, #4 generated by the key value generation module 30. The comparing operation may include at least one of an operation of identifying whether a key value was added, an operation of identifying whether a key value was duplicated, or an operation of identifying whether a key value was deleted.

The cache control signal generation module 42 may generate a control signal to transmit to the cache storage module 50 based on the comparison result of the key value comparison module 41. The control signal may include at least one of an instruction for deleting at least one key value in the latest cache, an instruction for adding at least one key value to the additional cache, or an instruction for adding at least one key value to the duplicate cache.

The cache control signal generation module 42 may transmit the generated control signal to the cache storage module 50 in operation S7.

For example, the key value comparison module 41 may identify that the key values #2, #3, #4 are duplicate. The cache control signal generation module 42 may generate a control signal for deleting the duplicate key values #2, #3, #4 from the key values #1, #2, #3, #4 stored in the latest cache. The cache control signal generation module 42 may generate a control signal for adding the duplicate key values #2, #3, #4 to the duplicate cache. The cache control signal generation module 42 may transmit the generated control signal to the cache storage module 50.

The cache storage module 50 my update the key values included in the cache based on the control signal generated by the cache control signal generation module 42. The operation of updating the key values included in the cache may include at least one of an operation of deleting the key values included in the latest cache, an operation of adding key values to the additional cache, or an operation of adding key values to the duplicate cache.

The key value analysis module 60 may be a module that determines the type of key values (or files) by analyzing the use history of the key values. The operation of analyzing the use history of key values may include an operation of identifying whether key values generated by the key value generation module 30 were added in the recent training process, whether the key values were used in the recent training process in the same manner as in the previous training process, whether the key values were used in the previous training process but were not used in the recent training process, or the like.

The key value analysis module 60 may receive a second control command for generating version information in operation S8. When the key value analysis module 60 receives the second control command, the key value analysis module 60 may call (or request) cache information in operation S9.

The cache information may indicate the key values stored in each of the latest cache, the additional cache, and the duplicate cache. The cache information may include at least one of the key values included in the latest cache, the key values included in the additional cache, or the key values included in the duplicate cache.

The cache storage module 50 may transmit the cache information to the key value analysis module 60 in response to the call for the cache information in operation S10. The key value analysis module 60 may include at least one of a key value number analysis module 61 or a key value type analysis module 62. The cache storage module 50 may transmit the cache information to at least one of the key value number analysis module 61 or the key value type analysis module 62.

The key value number analysis module 61 may identify (or calculate) the number of duplicate key values and the number of deleted key values based on the cache information. The key value number analysis module 61 may identify the number of the key values included in the duplicate cache as the first number based on the cache information. The key value number analysis module 61 may identify the number of the key values included in the latest cache as the second number based on the cache information. After the second control command was received, the key values included in the latest cache may be key values that are not duplicate, and the key values that are not duplicate may indicate key values that were deleted (or will be deleted).

For example, as there are three key values #2, #3, #4 included in the duplicate cache, and there is one key value #1 included in the latest cache, the key value number analysis module 61 may identify the first number (the number of the duplicate key values) as 3, and identify the second number (the number of the deleted key values) as 1.

The key value number analysis module 61 may transmit at least one of the obtained first number (the number of the duplicate key values) or second number (the number of the deleted key values) to the key value type analysis module 62 in operation S11.

The key value type analysis module 62 may determine whether key values are included in the additional cache in the cache information. If key values are included in the additional cache, the key value type analysis module 62 may identify the key values included in the additional cache as the first type (the add type).

The key value type analysis module 62 may compare the first number (the number of the duplicate key values) and the second number (the number of the deleted key values). The key value type analysis module 62 may generate key value information for each type based on the comparison result of the second number (the number of the deleted key values) and the first number (the number of the duplicate key values).

The key value type analysis module 62 may generate the key value information for each type based on the cache information received from the cache storage module 50 and the comparison result.

If the second number (the number of the deleted key values) is smaller than the first number (the number of the duplicate key values), the key value type analysis module 62 may identify the key values included in the latest cache (the deleted key values) as the third type (the del type).

If the second number (the number of the deleted key values) is not smaller than the first number (the number of the duplicate key values), the key value type analysis module 62 may identify the key values included in the duplicate cache (the duplicate key values) as the second type (the dup type).

The key value type analysis module 62 may transmit the key value information for each type to the version information generation module 70 in operation S12.

For example, if the first number (the number of the duplicate key values) is assumed as 3, and the second number (the number of the deleted key values) is assumed as 1, the key value type analysis module 62 may identify the key values included in the latest cache (the deleted key values) as the third type (the del type). The key value type analysis module 62 may transmit the key value information for each type (del: #1) to the version information generation module 70.

The version information generation module 70 may be a module that generates version information used in generating address information. The version information generation module 70 may generate version information corresponding to an artificial intelligence model by using the key value information for each type (del: #1) received from the key value type analysis module 60.

When the second version information v2 is generated, the version information generation module 70 may transmit an update command to the cache storage module 50. The update command may be a command for updating the caches store din the cache storage module 50. The update command may include a command for deleting the latest cache, and storing the values stored in the additional cache and the duplicate cache in the latest cache. The update command may include a command for deleting the additional cache and the duplicate cache when the latest cache is updated. The operations related to the update command may correspond to the operations S555, S560, and S565 in FIG. 5.

The version information generation module 70 may generated the second version information v2 corresponding to the second training data set based on the key value information for each type. The second version information v2 may be used in identifying the storage locations of the files f2, f3, f4 included in the second training data set.

The version information generation module 70 may transmit the second version information v2 to the key value management module 10 in operation S14.

The key value management module 10 may map the identification information of the second artificial intelligence model AI-2 obtained in the operation S2-1 and the second version information v2 obtained in the operation S13 and store them.

The version information may be stored in a new version whenever the artificial intelligence model is updated. For example, if the first artificial intelligence model is updated to the second artificial intelligence model, the first version information may be updated to the second version information. The key values #1, #2, #3, #4 stored in the first version information and the key value #1 stored in the second version information may be partially different. The type of the key values stored in the first version information (the first type, the add type) and the type of the key values stored in the second version information (the third type, the del type) may be different.

After the second version information is stored in the key value management module 10, the electronic apparatus 100 may receive a third control command requesting the files included in the second training data set in operation S15.

The third control command may be a command requesting information on the training data used in training of the second artificial intelligence model (the artificial intelligence model that was updated the most recently). The key value management module 10 may provide (or return or transmit) the information on the second training data set used in training of the second artificial intelligence model in response to the third control command. The key value management module 10 may return the key values indicating the locations of the at least one file f2, f3, f4 included in the second training data set.

When the third control command is received, the key value management module 10 may obtain address information indicating the storage locations of the files included in the second training data set based on at least one of the first version information or the second version information indicating the files included in the second training data set.

It is assumed that the addresses of the files included in the second training data set were requested. The key value management module 10 may identify the key values indicating the storage locations of the files included in the second training data set, and generate address information including the identified key values.

When the third control command is received, the key value management module 10 may determine whether key values of the second type (the dup type) are included in the second version information.

If key values of the second type (the dup type) are not included in the second version information, the key value management module 10 may additionally use the first version information corresponding to the previous version of the second version information. The key value management module 10 may identify the key values indicating the files included in the second training data set by using both of the first version information and the second version information. The key value management module 10 may generate address information including the identified key values #2, #3, #4.

If key values of the second type (the dup type) are included in the second version information, the key value management module 10 may identify key values of the first type (the add type) and key values of the second type (the dup type) included in the second version information. The key value management module 10 may generate address information including the key values of the first type (the add type) and the key values of the second type (the dup type). In case key values of the first type (the add type) do not exist, the key value management module 10 may generate address information including key values of the second type (the dup type).

The key value management module 10 may provide the generated address information in response to the third control command in operation S16.

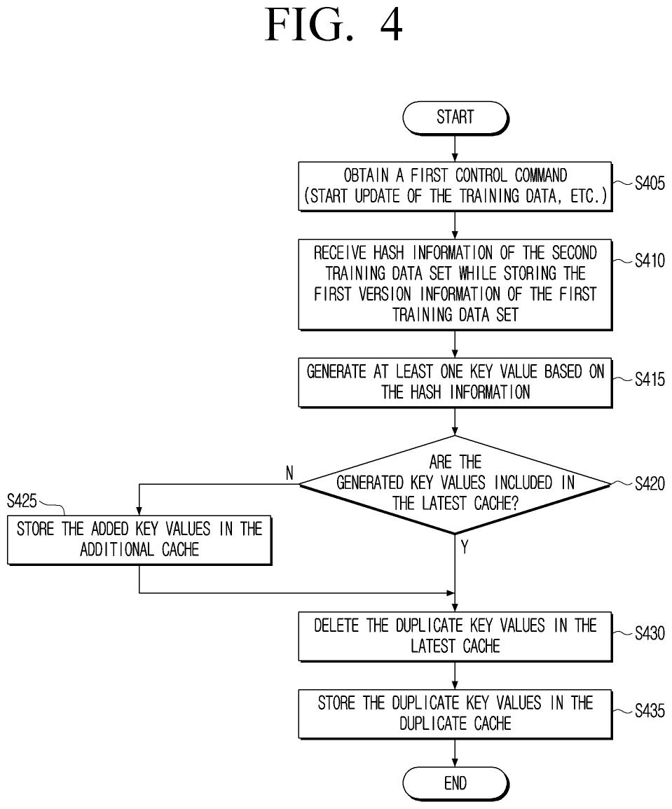

In FIG. 3, operations of each module were mainly described. In FIGS. 4 to 6, operations according to the time order will be mainly described.

FIG. 4 is a diagram for illustrating an operation of storing key values in a cache in an updating operation of training data according to an embodiment of the disclosure.

Referring to FIG. 4, the electronic apparatus 100 may obtain a first control command in operation S405. The first control command may be a starting command for updating the training data. The update may include an operation of newly storing training data or an operation of changing the training data.

After receiving the first control command, the electronic apparatus 100 may receive hash information of the second training data set while storing the first version information of the first training data set in operation S410. The hash information of the second training data set may include information indicating in which locations the files included in the second training data set are stored.

The electronic apparatus 100 may generate at least one key value based on the hash information in operation S415. The electronic apparatus 100 may generate key values indicating files included in the second training data set based on the received hash information. If there are a plurality of files, the electronic apparatus 100 may generate a plurality of key values corresponding to each of the plurality of files.

The electronic apparatus 100 may identify whether the generated at least one key value is included in the latest cache in operation S420. The electronic apparatus 100 may determine whether the key values included in the latest cache are identical to the generated at least one key value. The electronic apparatus 100 may identify added key values, duplicate key values, deleted key values, or the like, by comparing the key values included in the latest cache and the at least one key value.

If the generated at least one key value is not identical to the key values included in the latest cache in operation S420—N, the electronic apparatus 100 may identify the at least one key value as added key values, and store the added key values in the additional cache in operation S425.

If the generated at least one key value is identical to the key values included in the latest cache in operation S420—Y, the electronic apparatus 100 may identify duplicate key values identical to the at least one key value generated in the latest cache, and delete the duplicate key values in the latest cache in operation S430. The electronic apparatus 100 may store the duplicate key values in the duplicate cache in operation S435.

According to various embodiments of the disclosure, there may be a plurality of key values generated in the operation S615. Some of the plurality of key values may be identified as added key values, and the others may be identified as duplicate key values.

According to various embodiments of the disclosure, the electronic apparatus 100 may identify whether the generated key values are key values that were newly input but not key values included in the latest cache instead of the operation S620. If the generated key values are newly input key values, the electronic apparatus 100 may identify duplicate key values identical to the key values generated in the latest cache, and delete the duplicate key values in the latest cache. The electronic apparatus 100 may store the duplicate key values in the duplicate cache.

FIG. 5 is a diagram for illustrating an operation of updating version information of training data based on key values stored in a cache according to an embodiment of the disclosure.

Referring to FIG. 5, the electronic apparatus 100 may obtain a second control command in operation S505. The second control command may be a command for generating version information. The second control command may indicate that update related to the second training data set was finished. When the second control command is received, the electronic apparatus 100 may perform an operation of generating the second version information for the second training data set.

The electronic apparatus 100 may identify whether key values are included in the additional cache in operation S510. If key values are included in the additional cache in operation S510—Y, the electronic apparatus 100 may identify (or divide) the key values included in the additional cache as the first type (the add type) in operation S515.

The electronic apparatus 100 may obtain the number of the key values included in the duplicate cache (the first number) in operation S520. The electronic apparatus 100 may identify the first number as the number of duplicate files in the previous training data and the current training data.

The electronic apparatus 100 may obtain the number of the key values that were not deleted in the latest cache (the second number) in operation S525. The electronic apparatus 100 may identify the second number as the number of the deleted files in the previous training data.

The electronic apparatus 100 may compare the first number and the second number. The electronic apparatus 100 may identify whether the second number is smaller than the first number in operation S530. The electronic apparatus 100 may compare the number of the duplicated files (the first number) and the number of the deleted files (the second number).

If the second number is smaller than the first number in operation S530-Y, the electronic apparatus 100 may identify the key values included in the latest cache (the key values of the deleted files) as the third type (the del type) in operation S535.

The electronic apparatus 100 may generate the second version information including at least one of the key values identified as the first type (the add type) or the key values identified as the third type (the del type) in operation S530.

In case there are values identified as the first type (the add type) in the operation S515, the electronic apparatus 100 may generate the second version information including both of the key values identified as the first type (the add type) and the key values identified as the third type (the del type).

In case there are no key values identified as the first type (the add type) in the operation S515, the electronic apparatus 100 may generate the second version information including all of the key values identified as the third type (the del type).

If the second number is not smaller than the first number in operation S530—N, the electronic apparatus 100 may identify the key values included in the duplicate cache (the key values of the duplicate file) as the second type (the dup type) in operation S545.

The electronic apparatus 100 may generate the second version information including at least one of the key values identified as the first type (the add type) or the key values identified as the second type (the dup type) in operation S550.

In case there are key values identified as the first type (the add type) in the operation S515, the electronic apparatus 100 may generate the second version information including both of the key values identified as the first type (the add type) and the key values identified as the second type (the dup type).

In case there are no key values identified as the first type (the add type) in the operation S515, the electronic apparatus 100 may generate the second version information including all of the key values identified as the second type (the dup type).

After the second version information is generated, the electronic apparatus 100 may delete the key values included in the latest cache in operation S555.

The electronic apparatus 100 may store the key values included in at least one of the additional cache or the duplicate cache in the latest cache in operation S560. additional cache and the duplicate cache in operation S565. When the operation S565 is performed, only the key values included in the files used in the current training process may be included in the latest cache. The electronic apparatus 100 may obtain (or identify) the storage locations of the files used in training of the artificial intelligence model by using the key values stored in the latest cache.

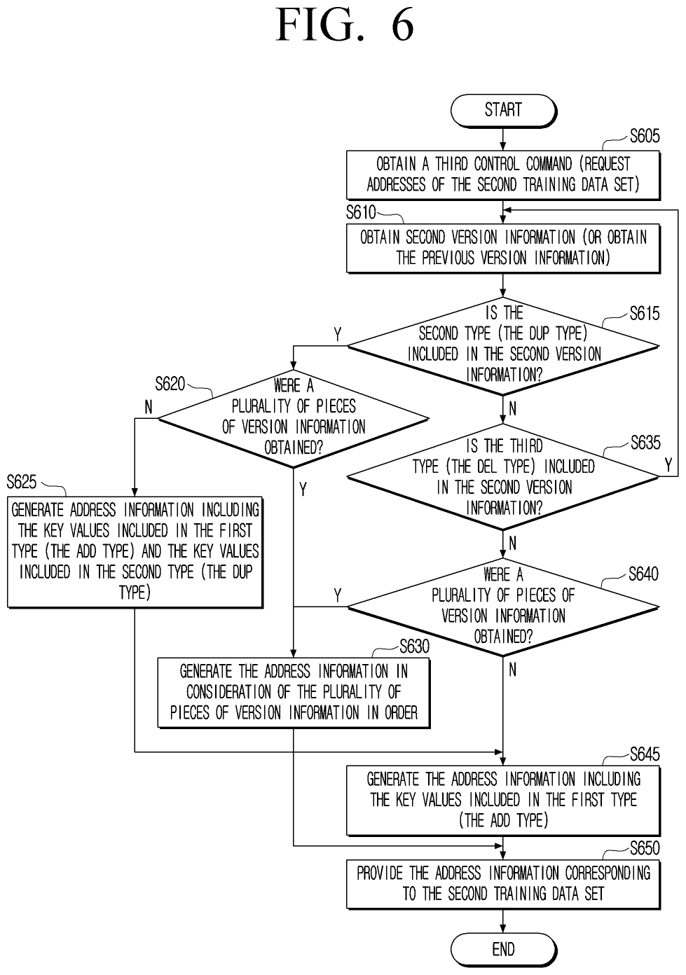

FIG. 6 is a diagram for illustrating an operation of providing address information of files included in a training data set according to an embodiment of the disclosure.

Referring to FIG. 6, the electronic apparatus 100 may obtain a third control command in operation S605. The third control command may be a command requesting the addresses of the second training data set. Addresses of the files included in the second training data set may be needed for obtaining the files included in the second training data set. The third control command may be a command requesting the addresses of the files included in the second training data set.

The electronic apparatus 100 may obtain the version information (the version information that was stored the most recently) in operation S610. The electronic apparatus 100 may identify whether key values of the second type (the dup type) are included in the second version information in operation S615.

If key values of the second type (the dup type) are included in the second version information in operation S615—Y, the electronic apparatus 100 may identify whether a plurality of pieces of version information were obtained for generating address information in operation S620.

If a plurality of pieces of version information were not obtained in operation S620—Y, the electronic apparatus 100 may generate address information including key values included in the first type (the add type) and the key values included in the second type (the dup type) in operation S625.

When a plurality of pieces of version information are obtained in operation S620—Y, the electronic apparatus 100 may generate version information based on the plurality of pieces of version information in order in operation S630. It is assumed that the electronic apparatus 100 obtained the first version information in the first order and the second version information in the second order. The electronic apparatus 100 may identify the files included in the second training data set based on the first version information and the second version information in order. The electronic apparatus 100 may generate address information including the key values of the files included in the second training data set.

If key values of the second type (the dup type) are not included in the second version information in operation S615—N, the electronic apparatus 100 may identify whether key values of the third type (the del type) are included in the second version information in operation S635.

If key values of the third type (the del type) are included in the second version information in operation S635—N, the electronic apparatus 100 may identify whether a plurality of pieces of version information were obtained for generating address information in operation S640.

If a plurality of pieces of version information were not obtained in operation S640—N, the electronic apparatus 100 may generate address information including key values included in the first type (the add type) in operation S645.

If a plurality of pieces of version information are obtained in operation S640—Y, the electronic apparatus 100 may generate address information based on the plurality of pieces of version information in order in operation S630. It is assumed that the electronic apparatus 100 obtained the first version information in the first order and the second version information in the second order. The electronic apparatus 100 may identify the files included in the second training data set based on the first version information and the second version information in order. The electronic apparatus 100 may generate address information including the key values of the files included in the second training data set.

When the address information is generated, the electronic apparatus 100 may provide address information corresponding to the second training data set in operation S650.

According to various embodiments of the disclosure, as a plurality of pieces of version information are already stored in the memory, or the like, the operation of obtaining the version information in FIG. 4 may indicate an operation of extracting or activating the previously stored version information such that the information can be used in a separate calculating operation.

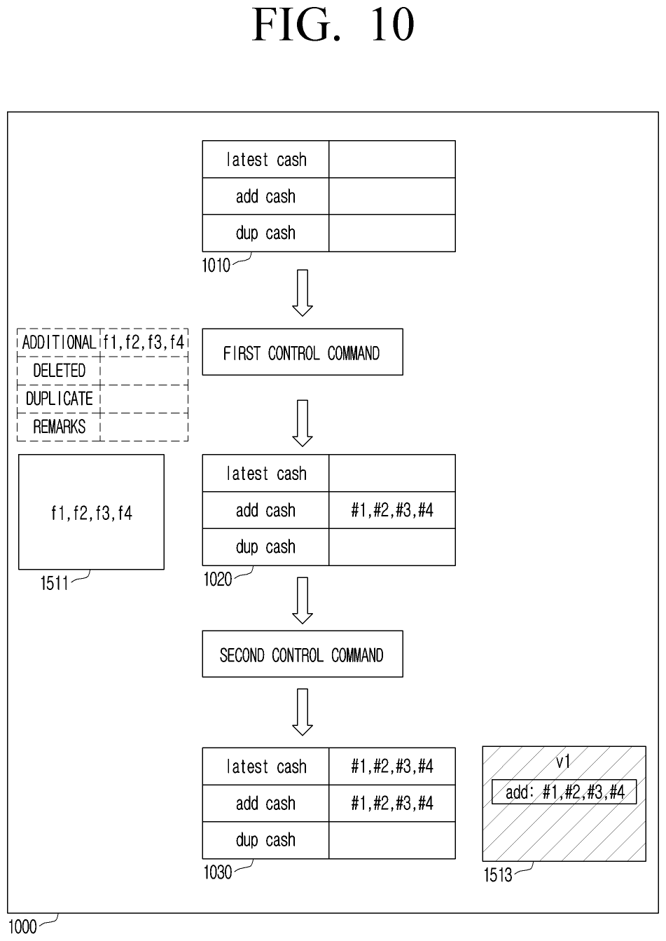

According to various embodiments of the disclosure, an operation of identifying key values for each type will be described in FIGS. 10 to 15.

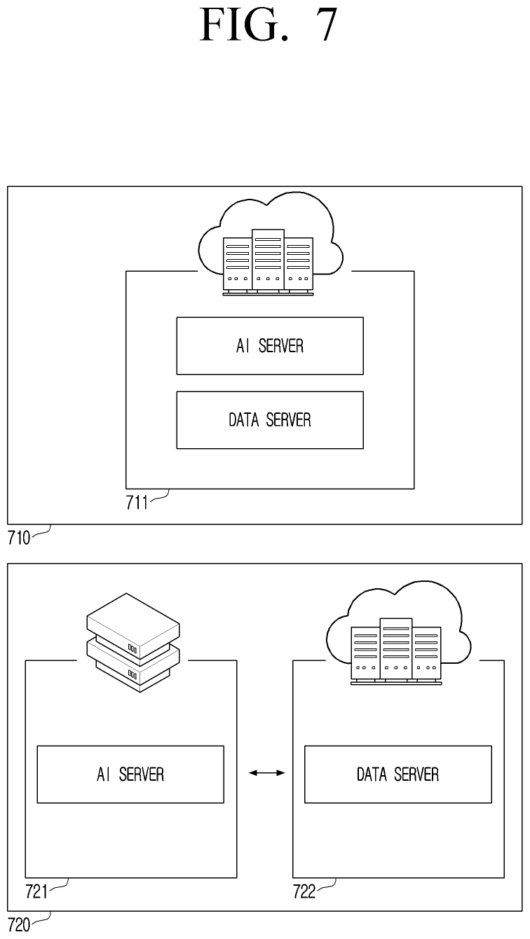

FIGS. 4 to 6 explained a series of operations that were performed as each of the first control command, the second control command, and the third control command was received. The subjects performing the operations described above may be different. As an example, most operations may be performed in one server. In addition, as an example, different servers may perform their respective operations by dividing their respective roles. Explanation in this regard will be described in FIG. 7.

FIG. 7 is a diagram for illustrating a relation between an artificial intelligence server and a data server according to an embodiment of the disclosure.

Referring to the embodiment 710 in FIG. 7, an integrated server 711 may include both of an AI server and a data server.

The AI server may be a server that performs various operations related to an artificial intelligence model. The AI server may indicate at least one of a server training an artificial intelligence model, a server storing the trained artificial intelligence model, or a server providing (or transmitting) the trained artificial intelligence model.

The data server may be a server that stores data. In addition, the data server may be a server that performs management of data. The data server may also be described as a data storage server, a data management server, a data control server, or the like.

Referring to the embodiment 720 in FIG. 7, a first server 721 may include an AI server. A second server 722 may include a data server. Unlike in the embodiment 710, the AI server and the data server may be included in separate servers. The first server 721 may include an AI server for training the artificial intelligence model. The first server 721 may request training data to the second server 722 including a data server. The first server 721 may receive training data from the data server, and perform a training operation for the artificial intelligence model based on the received training data.

The data server described in FIG. 7 may store and mange various types of data. The data stored in the data server will be explained in FIG. 8.

FIG. 8 is a diagram for illustrating a data set, hash information, key values, or the like, according to an embodiment of the disclosure.

Referring to FIG. 8, a plurality of files may be included in the original data set. The original data set may include a plurality of original files. In a state wherein each of the plurality of files is stored while being included in the original data set, each of the plurality of files may be divided in a package unit in the original data set.

Files used in a training process of the artificial intelligence model may be included in an original data set 810. The original data set 810 may also be described as the original file set. The original data set 810 may indicate groups of files that were used or has a possibility of being used in the training process.

The at least one file f1, f2, f3, f4, f5, f6, f7, f8 included in the original data set 810 may be divided in a predetermined unit (a package). Each package may be divided into areas of a predetermined number (four) (an area, a b area, a c area, a d area). Each area of a package may be identified by physical location information. The physical location information (a, b, c, d) may be information indicating a specific area among a plurality of areas included in a package.

The first file f1 may be stored in the first area a of the first package. The second file f2 may be stored in the second area b of the first package. The third file f3 may be stored in the third area c of the first package. The fourth file f4 may be stored in the fourth area d of the first package.

The fifth file f5 may be stored in the first area a of the second package. The sixth file f6 may be stored in the second area b of the second package. The seventh file f7 may be stored in the third area c of the second package. The eighth file f8 may be stored in the fourth area d of the second package.

A package may be a unit dividing files in a group. A package may indicate a data package. The physical location information may indicate relative storage locations in a package. The physical location information may include information specifying one area among a plurality of areas included in a package.

For example, the original data set may include a first package and a second package. The first package may include at least one file f1, f2, f3, f4, and the second package may include at least one file f5, f6, f7, f8. Each package may include a first area (an a area), a second area (a b area), a third area (a c area), and a fourth area (a d area). In each area of a package, different files may be stored.

Hash information may be used for indicating files used in a training process. A hash information set 820 may include information indicating storage locations of at least one file included in the original data set. The hash information set 820 may include a plurality of pieces of hash information.

The hash information may include at least one of package information (tid) or physical location information (position). The hash information may be different for each file. This is because the stored location of each file is different.

The hash information set 820 may include hash information for files included in the original data set 810.

It is assumed that the key value generation module 30 in FIG. 3 generates key values for the hash information set 820. The key value generation module 30 may obtain a key value set 830. The key value generation module 30 may identify a subject file for generating key values. The key value generation module 30 may generate key values corresponding to the identified subject file.

A calculation example of the hash information and the key value information generated by using the data explained in FIG. 8 will be described in FIG. 9.

FIG. 9 is a diagram for illustrating an operation of generating key values according to an embodiment of the disclosure.

Referring to the embodiment 900 in FIG. 9, it is assumed that at least one file f2, f3, f4 are included in a second training data set 910. A hash information generation module 80 may receive information for the at least one file f2, f3, f4 used in a training process. The information on the at least one file f2, f3, f4 may indicate identification information of the files. The identification information of the files may include names, file numbers, or the like.

When the information on the at least one file f2, f3, f4 is received, the hash information generation module 80 may identify the at least one file f2, f3, f4 stored in the original data set 810 in FIG. 8 based on the information on the at least one file f2, f3, f4. Package information and physical location information of the files may be identified based on the original data set 810. The hash information generation module 80 may generate hash information 920 for the at least one file f2, f3, f4. The hash information generation module 80 may transmit the generated hash information 920 to the key value generation module 30.

As an example, the hash information generation module 80 may be included in the electronic apparatus 100. The electronic apparatus 100 may generate (or obtain) hash information by itself.

As an example, the hash information generation module 80 may be included in an external apparatus but not the electronic apparatus 100. The electronic apparatus 100 may receive the hash information generated in the external apparatus.

The key value generation module 30 may receive the hash information 920 generated by the hash information generation module 80. The key value generation module 30 may generate (or obtain) key value information based on the hash information 920. The key value information may also be described as a key value set. The key value information may include at least one key value.

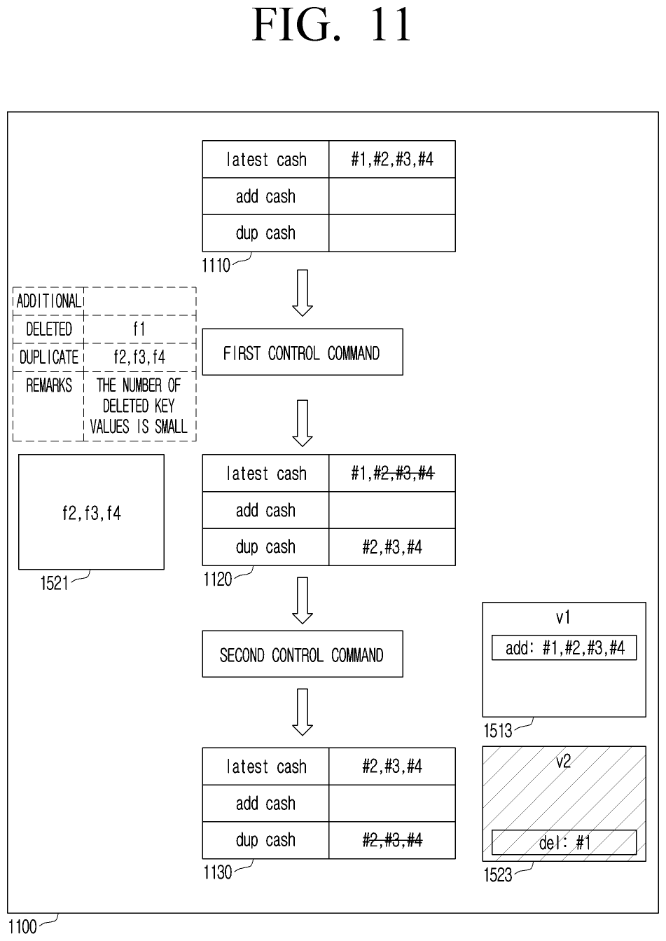

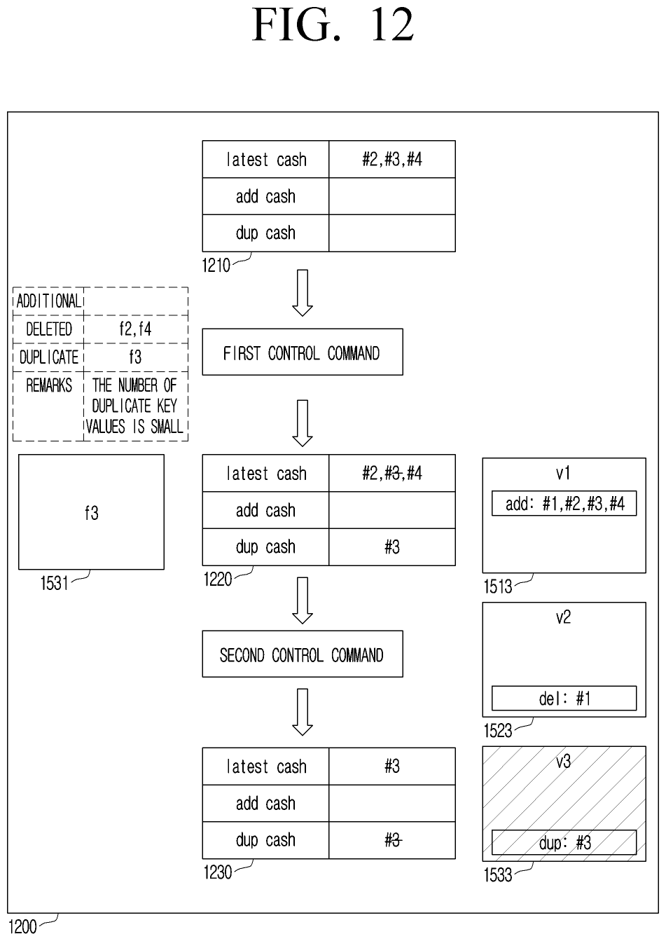

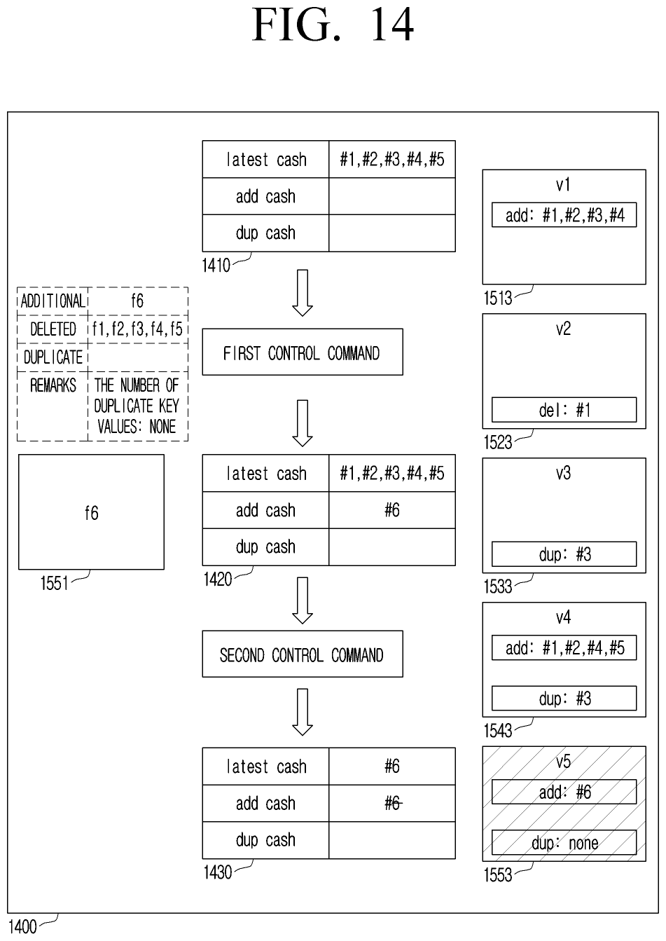

In FIGS. 10 to 14, an operation of generating version information according to a training process and a cache control process will be explained in order. FIG. 10 explains a process wherein version information 1513 is generated according to a first embodiment. FIG. 11 explains a process wherein version information 1523 is generated according to a second embodiment after the version information 1513 is generated. FIG. 12 explains a process wherein version information 1533 is generated according to a third embodiment after the version information 1523 is generated. FIG. 13 explains a process wherein version information 1543 is generated according to a fourth embodiment after the version information 1533 is generated. FIG. 14 explains a process wherein version information 1553 is generated according to a fifth embodiment after the version information 1543 is generated.

FIG. 10 is a diagram for illustrating an operation of generating version information according to a training process according to an embodiment of the disclosure.

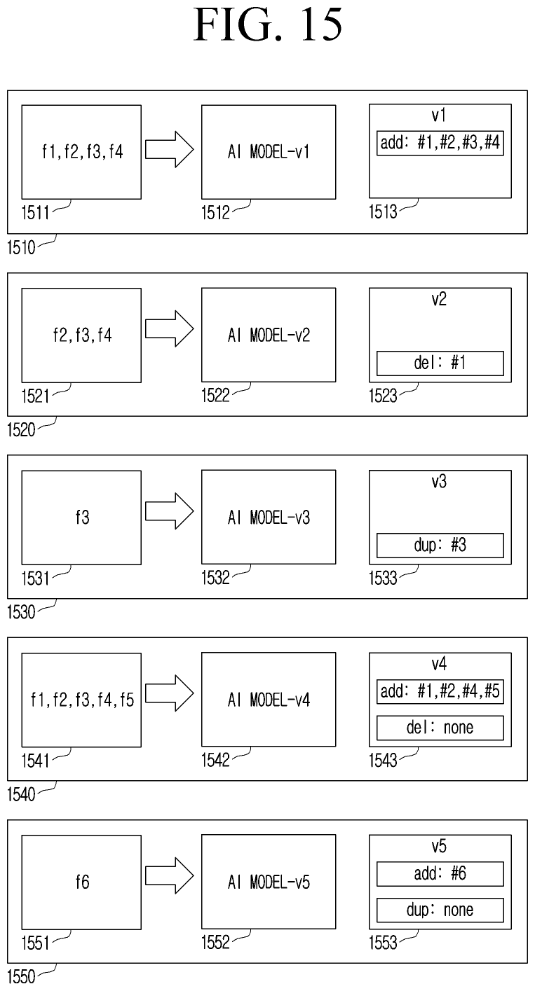

An embodiment 1000 in FIG. 10 may correspond to the embodiment 1510 in FIG. 15. The electronic apparatus 100 may receive a first control command (e.g., a command for starting update of training data). When the first control command is received, the electronic apparatus 100 may identify at least one file f1, f2, f3, f4 included in a training data set 1511 by using information on the training data set 1511 (e.g., hash information) that trained the artificial intelligence model 1512. The electronic apparatus 100 may generate key values #1, #2, #3, #4 of the at least one file f1, f2, f3, f4.

When the key values are generated, the electronic apparatus 100 may identify (or obtain or call) first cash information 1010. The first cache information 1010 may be cache information that was stored the most recently. The electronic apparatus 100 may obtain second cache information 1020 by reflecting the generated key values #1, #2, #3, #4 to the first cache information 1010.

The electronic apparatus 100 may receive a second control command (e.g., a command for finishing update) after obtaining the second cache information 1020.

When the second control command is received, the electronic apparatus 100 may generate version information 1513. The electronic apparatus 100 may obtain key values for each type (add: #1, #2, #3, #4) based on the second cache information 1020. The electronic apparatus 100 may generate the version information 1513 including the key values for each type (add: #1, #2, #3, #4). The operation of generating the version information 1513 will be described in the operations S505, S510, S515, S520, S525, S530, S535, S540, S545, and S550 in FIG. 5.

When the version information 1513 is generated, the electronic apparatus 100 may update the latest cache included in the second cache information 1020. The electronic apparatus 100 may obtain the third cache information 1030 by updating the second cache information 1020.

The electronic apparatus 100 may delete the key value included in the latest cache, and store the key values included in the additional cache and the duplicate cache in the latest cache. When the latest cache is changed, the electronic apparatus 100 may delete the key values included in the additional cache and the duplicate cache. An operation in this regard will be described in the operations S555, S560, and S565 in FIG. 5.

The electronic apparatus 100 may use the version information for identifying the address locations of files used in a training process of the artificial intelligence model. The version information may be generated whenever a training process is completed once.

As a training process was performed once in the embodiment 1000 in FIG. 10, one version information 1513 may be stored in the electronic apparatus 100. The electronic apparatus 100 may generate and provide address information (including key values) for the at least one file used in the training process of the artificial intelligence model based on the version information 1513.

FIG. 11 is a diagram for illustrating an operation of generating version information according to a training process according to an embodiment of the disclosure.

Referring to in FIG. 11, an embodiment 1100 may correspond to the embodiment 1520 in FIG. 15. The electronic apparatus 100 may receive a first control command (e.g., a command for starting update of training data). When the first control command is received, the electronic apparatus 100 may identify at least one file f2, f3, f4 included in a training data set 1521 by using information on the training data set 1521 (e.g., hash information) that trained the artificial intelligence model 1522. The electronic apparatus 100 may generate key values #2, #3, #4 of the at least one file f2, f3, f4.

When the key values are generated, the electronic apparatus 100 may identify (or obtain or call) first cash information 1110. The first cache information 1110 may be cache information that was stored the most recently. The electronic apparatus 100 may obtain second cache information 1120 by reflecting the generated key values #2, #3, #4 to the first cache information 1110.

The electronic apparatus 100 may receive a second control command (e.g., a command for finishing update) after obtaining the second cache information 1120.

When the second control command is received, the electronic apparatus 100 may generate version information 1523. The electronic apparatus 100 may obtain key values for each type (del: #1) based on the second cache information 1120. The electronic apparatus 100 may generate the version information 1523 including the key values for each type (del: #1). The operation of generating the version information 1523 will be described in the operations S505, S510, S515, S520, S525, S530, S535, S540, S545, and S550 in FIG. 5.

When the version information 1523 is generated, the electronic apparatus 100 may update the latest cache included in the second cache information 1120. The electronic apparatus 100 may obtain the third cache information 1130 by updating the second cache information 1120.

The electronic apparatus 100 may delete the key values included in the latest cache, and store the key values included in the additional cache and the duplicate cache in the latest cache. When the latest cache is changed, the electronic apparatus 100 may delete the key values included in the additional cache and the duplicate cache. An operation in this regard will be described in the operations S555, S560, and S565 in FIG. 5.

As the training process was performed twice in the embodiment 1100 in FIG. 11, a plurality of pieces of version information 1513, 1523 may be stored in the electronic apparatus 100. The electronic apparatus 100 may generate and provide address information (including key values) for the at least one file used in the training process of the artificial intelligence model based on the plurality of pieces of version information 1513, 1523. The plurality of pieces of version information 1513, 1523 may include information on the order of generation (including the time point of generation, or the like). The electronic apparatus 100 may analyze the plurality of pieces of version information 1513, 1523 in order based on the information on the order of generation of each version information. The electronic apparatus 100 may generate and provide the address information (including the key values) based on the analysis result.

FIG. 12 is a diagram for illustrating an operation of generating version information according to a training process according to an embodiment of the disclosure.

Referring to FIG. 12, an embodiment 1200 may correspond to the embodiment 1530 in FIG. 15. The electronic apparatus 100 may receive a first control command (e.g., a command for starting update of training data). When the first control command is received, the electronic apparatus 100 may identify at least one file f3 included in the training data set 1531 by using information on the training data set 1531 (e.g., hash information) that trained the artificial intelligence model 1532. The electronic apparatus 100 may generate a key value #3 of the at least one file f3.

When the key value is generated, the electronic apparatus 100 may identify (or obtain or call) the first cache information 1210. The first cache information 1210 may be cache information that was stored the most recently. The electronic apparatus 100 may obtain the second cache information 1220 by reflecting the generated key value #3 to the first cache information 1210.

The electronic apparatus 100 may receive a second control command (e.g., a command for finishing update) after obtaining the second cache information 1220.

When the second control command is received, the electronic apparatus 100 may generate version information 1533. The electronic apparatus 100 may obtain key values for each type (dup: #3) based on the second cache information 1220. The electronic apparatus 100 may generate the version information 1533 including the key values for each type (dup: #3). The operation of generating the version information 1533 will be described in the operations S505, S510, S515, S520, S525, S530, S535, S540, S545, and S550 in FIG. 5.

When the version information 1533 is generated, the electronic apparatus 100 may update the latest cache included in the second cache information 1220. The electronic apparatus 100 may obtain the third cache information 1230 by updating the second cache information 1220.

The electronic apparatus 100 may delete the key values included in the latest cache, and store the key values included in the additional cache and the duplicate cache in the latest cache. When the latest cache is changed, the electronic apparatus 100 may delete the key values included in the additional cache and the duplicate cache. An operation in this regard will be described in the operations S555, S560, and S565 in FIG. 5.

As the training process was performed three times in the embodiment 1200 in FIG. 12, a plurality of pieces of version information 1513, 1523, 1533 may be stored in the electronic apparatus 100. The electronic apparatus 100 may generate and provide address information (including key values) for the at least one file used in the training process of the artificial intelligence model based on the plurality of pieces of version information 1513, 1523, 1533. The plurality of pieces of version information 1513, 1523, 1533 may include information on the order of generation (including the time point of generation, or the like). The electronic apparatus 100 may analyze the plurality of pieces of version information 1513, 1523, 1533 in order based on the information on the order of generation of each version information. The electronic apparatus 100 may generate and provide the address information (including the key values) based on the analysis result.

FIG. 13 is a diagram for illustrating an operation of generating version information according to a training process according to an embodiment of the disclosure.

Referring to FIG. 12, an embodiment 1300 may correspond to the embodiment 1540 in FIG. 15. The electronic apparatus 100 may receive a first control command (e.g., a command for starting update of training data). When the first control command is received, the electronic apparatus 100 may identify at least one file f1, f2, f3, f4, f5 included in the training data set 1541 by using information on the training data set 1541 (e.g., hash information) that trained the artificial intelligence model 1542. The electronic apparatus 100 may generate key values #1, #2, #3, #4 of the at least one file f1, f2, f3, f4, f5.

When the key values are generated, the electronic apparatus 100 may identify (or obtain or call) the first cache information 1310. The first cache information 1310 may be cache information that was stored the most recently. The electronic apparatus 100 may obtain the second cache information 1320 by reflecting the generated key values #1, #2, #3, #4 to the first cache information 1310.

The electronic apparatus 100 may receive a second control command (e.g., a command for finishing update) after obtaining the second cache information 1320.

When the second control command is received, the electronic apparatus 100 may generate version information 1543. The electronic apparatus 100 may obtain key values for each type (add: #1, #2, #4, #5) (del: none) based on the second cache information 1320. The electronic apparatus 100 may generate the version information 1543 including the key values for each type (add: #1, #2, #4, #5) (del: none). The operation of generating the version information 1543 will be described in the operations S505, S510, S515, S520, S525, S530, S535, S540, S545, and S550 in FIG. 5.

When the version information 1543 is generated, the electronic apparatus 100 may update the latest cache included in the second cache information 1320. The electronic apparatus 100 may obtain third cash information 1330 by updating the second cache information 1320.

The electronic apparatus 100 may delete the key values included in the latest cache, and store the key values included in the additional cache and the duplicate cache in the latest cache. When the latest cache is changed, the electronic apparatus 100 may delete the key values included in the additional cache and the duplicate cache. An operation in this regard will be described in the operations S555, S560, and S565 in FIG. 5.

As the training process was performed four times in the embodiment 1300 in FIG. 13, a plurality of pieces of version information 1513, 1523, 1533, 1543 may be stored in the electronic apparatus 100. The electronic apparatus 100 may generate and provide address information (including key values) for the at least one file used in the training process of the artificial intelligence model based on the plurality of pieces of version information 1513, 1523, 1533, 1543. The plurality of pieces of version information 1513, 1523, 1533, 1543 may include information on the order of generation (including the time point of generation, or the like). The electronic apparatus 100 may analyze the plurality of pieces of version information 1513, 1523, 1533, 1543 in order based on the information on the order of generation of each version information. The electronic apparatus 100 may generate and provide the address information (including the key values) based on the analysis result.

FIG. 14 is a diagram for illustrating an operation of generating version information according to a training process according to an embodiment of the disclosure.

Referring to FIG. 14, an embodiment 1400 may correspond to the embodiment 1550 in FIG. 15. The electronic apparatus 100 may receive a first control command (e.g., a command for starting update of training data). When the first control command is received, the electronic apparatus 100 may identify at least one file f6 included in the training data set 1551 by using information on the training data set 1551 (e.g., hash information) that trained the artificial intelligence model 1552. The electronic apparatus 100 may generate key values #1, #2, #3, #4 of the at least one file f6.

When the key values are generated, the electronic apparatus 100 may identify (or obtain or call) first cash information 1410. The first cache information 1410 may be cache information that was stored the most recently. The electronic apparatus 100 may obtain second cache information 1420 by reflecting the generated key values #1, #2, #3, #4 to the first cache information 1410.

The electronic apparatus 100 may receive a second control command (e.g., a command for finishing update) after obtaining the second cache information 1420.

When the second control command is received, the electronic apparatus 100 may generate version information 1553. The electronic apparatus 100 may obtain key values for each type (add: #6) (dup: none) based on the second cache information 1420. The electronic apparatus 100 may generate the version information 1553 including the key values for each type (add: #6) (dup: none). The operation of generating the version information 1553 will be described in the operations S505, S510, S515, S520, S525, S530, S535, S540, S545, and S550 in FIG. 5.

When the version information 1553 is generated, the electronic apparatus 100 may update the latest cache included in the second cache information 1420. The electronic apparatus 100 may obtain the third cache information 1430 by updating the second cache information 1420.

The electronic apparatus 100 may delete the key values included in the latest cache, and store the key values included in the additional cache and the duplicate cache in the latest cache. When the latest cache is changed, the electronic apparatus 100 may delete the key values included in the additional cache and the duplicate cache. An operation in this regard will be described in the operations S555, S560, and S565 in FIG. 5.

As the training process was performed five times in the embodiment 1500 in FIG. 15, a plurality of pieces of version information 1513, 1523, 1533, 1543, 1553 may be stored in the electronic apparatus 100. The electronic apparatus 100 may generate and provide address information (including key values) for the at least one file used in the training process of the artificial intelligence model based on the plurality of pieces of version information 1513, 1523, 1533, 1543, 1553. The plurality of pieces of version information 1513, 1523, 1533, 1543, 1553 may include information on the order of generation (including the time point of generation, or the like). The electronic apparatus 100 may analyze the plurality of pieces of version information 1513, 1523, 1533, 1543, 1553 in order based on the information on the order of generation of each version information. The electronic apparatus 100 may generate and provide the address information (including the key values) based on the analysis result.

FIGS. 10 to 14 explained version information generated according to a continuous training process. Each embodiment is expressed as one drawing as in FIG. 15.

FIG. 15 is a diagram for illustrating a plurality of training processes according to an embodiment of the disclosure.

Referring to FIG. 15, the artificial intelligence model may be updated as it is trained a plurality of times. The five types of embodiments 1510, 1520, 1530, 1540, 1550 in FIG. 15 may correspond to the embodiment (2) in FIG. 1 or the embodiments in FIGS. 10 to 14.

The electronic apparatus 100 may generate version information for each training process. The version information may be information indicating whether files were used in a training process of the artificial intelligence model. The version information may include key values for each type. The key values for each type may also be described as key value information for each type or type-key value mapping information, or the like.

According to the embodiment 1510, the artificial intelligence model 1512 may be a model that was trained by the training data set 1511. The training data set 1511 may include at least one file f1, f2, f3, f4. The electronic apparatus 100 may generate version information 1513 corresponding to the training data set 1511. The version information 1513 may include key values for each type (add: #1, #2, #3, #4).

According to the embodiment 1520, the artificial intelligence model 1522 may be a model that was trained by the training data set 1521. The training data set 1521 may include at least one file f2, f3, f4. The electronic apparatus 100 may generate version information 1523 corresponding to the training data set 1521. The version information 1513 may include key values for each type (del: #1).

According to the embodiment 1530, the artificial intelligence model 1532 may be a model that was trained by the training data set 1531. The training data set 1531 may include at least one file f3. The electronic apparatus 100 may generate version information 1533 corresponding to the training data set 1531. The version information 1533 may include key values for each type (dup: #3).

According to the embodiment 1540, the artificial intelligence model 1542 may be a model that was trained by the training data set 1541. The training data set 1541 may include at least one file f1, f2, f3, f4, f5. The electronic apparatus 100 may generate version information 1543 corresponding to the training data set 1541. The version information 1543 may include key values for each type (add: #1, #2, #4, #5) (del: none).

According to the embodiment 1550, the artificial intelligence model 1552 may be a model that was trained by the training data set 1551. The training data set 1551 may include at least one file f6. The electronic apparatus 100 may generate version information 1553 corresponding to the training data set 1551. The version information 1553 may include key values for each type (add: #6) (dup: none).

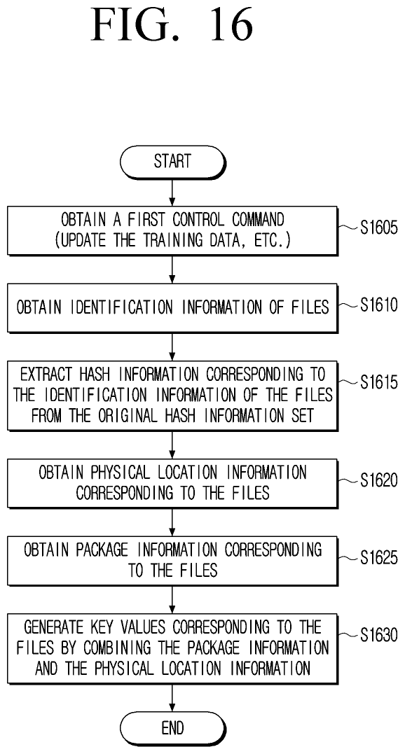

In FIGS. 4 to 6, a plurality of operations according to an embodiment were explained. A plurality of operations according to an embodiment different from the embodiment disclosed in FIGS. 4 to 6 will be described in FIGS. 16 to 19.

FIG. 16 is a diagram for illustrating an operation of generating key values according to an embodiment of the disclosure.

Referring to FIG. 16, the electronic apparatus 100 may obtain a first control command in operation S1605. The first control command may be a starting command for updating the training data.

The electronic apparatus 100 may identify file(s) included in the training data set. The files may also be described as at least one file. The electronic apparatus 100 may obtain identification information of the file(s) included in the training data set in operation S1610.

The electronic apparatus 100 may extract hash information corresponding to identification information of files from the original hash information set in operation S1615. The original hash information set may be a data set wherein files having a possibility of being used in the training process are stored. Explanation in this regard will be described in FIG. 8.

The electronic apparatus 100 may extract (or identify) hash information corresponding to the identification information of the files obtained in the operation S1610 among the plurality of pieces of hash information in operation S1615.

The electronic apparatus 100 may obtain physical location information corresponding to the files based on the hash information in operation S1620. The electronic apparatus 100 may obtain package information corresponding to the files based on the hash information in operation S1625.

The electronic apparatus 100 may generate key values corresponding to the files by combining the package information and the physical location information in operation S1630.

The operations S1605 to S1630 disclosed in FIG. 16 may be performed through the key value generation module 30 in FIG. 3.

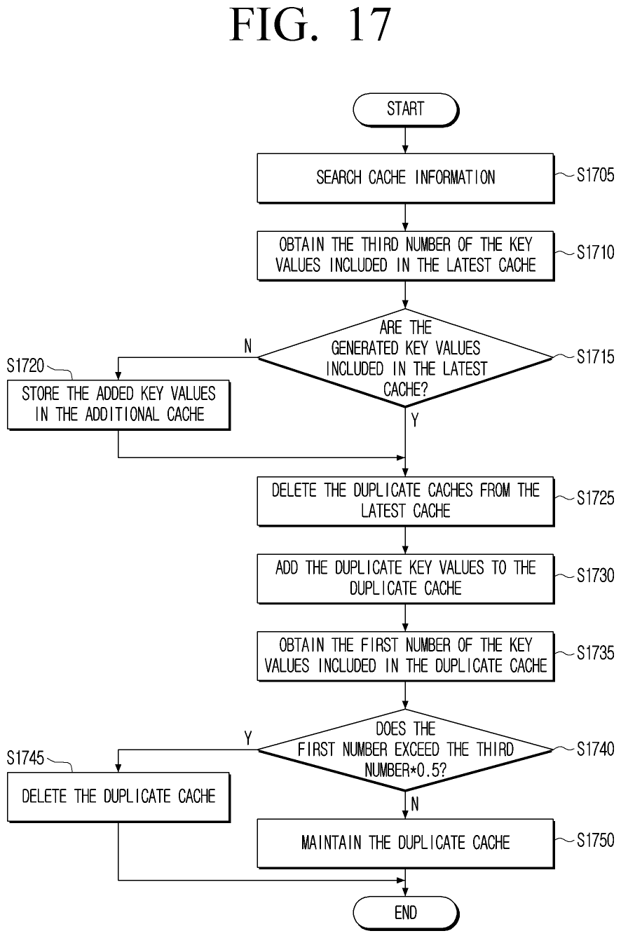

FIG. 17 is a diagram for illustrating an operation of controlling a cache according to an embodiment of the disclosure.

Referring to FIG. 17, the electronic apparatus 100 may search (or obtain or identify) cache information after the operation of generating key values (S1630) in FIG. 16 in operation S1705. The cache information may include at least one of the latest cache, the additional cache, or the duplicate cache.

The electronic apparatus 100 may obtain the number of the key values included in the latest cache (the third number) in operation S1630.

The electronic apparatus 100 may identify whether the key values generated in the operation S1630 in FIG. 16 are included in the latest cache in operation S1715. If the generated key values are not included in the latest cache in operation S1715—N, the electronic apparatus 100 may store the added key values in the additional cache in operation S1720.

If the generated key values are included in the latest cache in operation S1715—Y, the electronic apparatus 100 may delete the duplicate key values in the latest cache in operation S1725. The electronic apparatus 100 may add the duplicate key values to the duplicate cache in operation S1730. The electronic apparatus 100 may obtain the number of the key values included in the duplicate cache (the first number) in operation S1735.

The electronic apparatus 100 may compare the first number and a half of the third number (0.5*the third number). If the first number exceeds the half of the third number in operation S1740—Y, the electronic apparatus 100 may delete the duplicate cache in operation S1745. If the first number does not exceed the half of the third number in operation S1740—N, the electronic apparatus 100 may maintain the duplicate cache in operation S1750.

The half of the third number may be obtained by multiplying the third number by 0.5, and rounding off (or rounding down) from the first decimal place. For example, if the third number is 3, the half of the third number may be 1.5. The electronic apparatus 100 may round off the half of the third number from the first decimal place of 1.5, and determine it as 2.

According to various embodiments of the disclosure, the operations S1705 to S1750 in FIG. 17 may be performed by the cache control module 40 in FIG. 3.

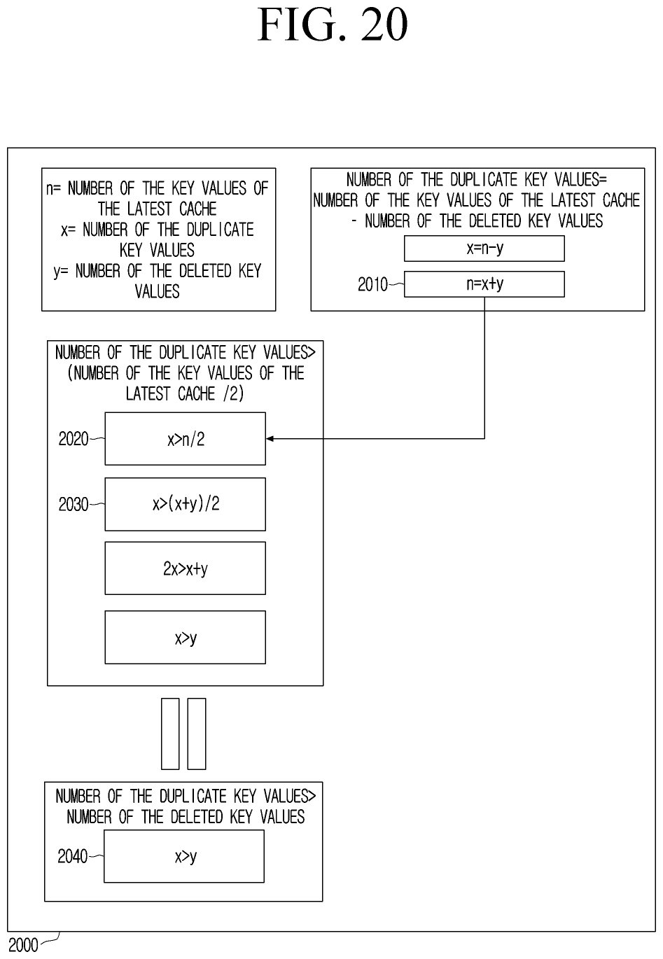

According to various embodiments of the disclosure, the operation S1740 in FIG. 17 may correspond to the operation S530. Accordingly, the comparing operations in each embodiment may be replaced by one another. For example, an embodiment of comparing the first number and the second number and an operation of comparing the first number and the half of the third number may correspond to each other. A mathematical access method related to this will be described in FIG. 20.

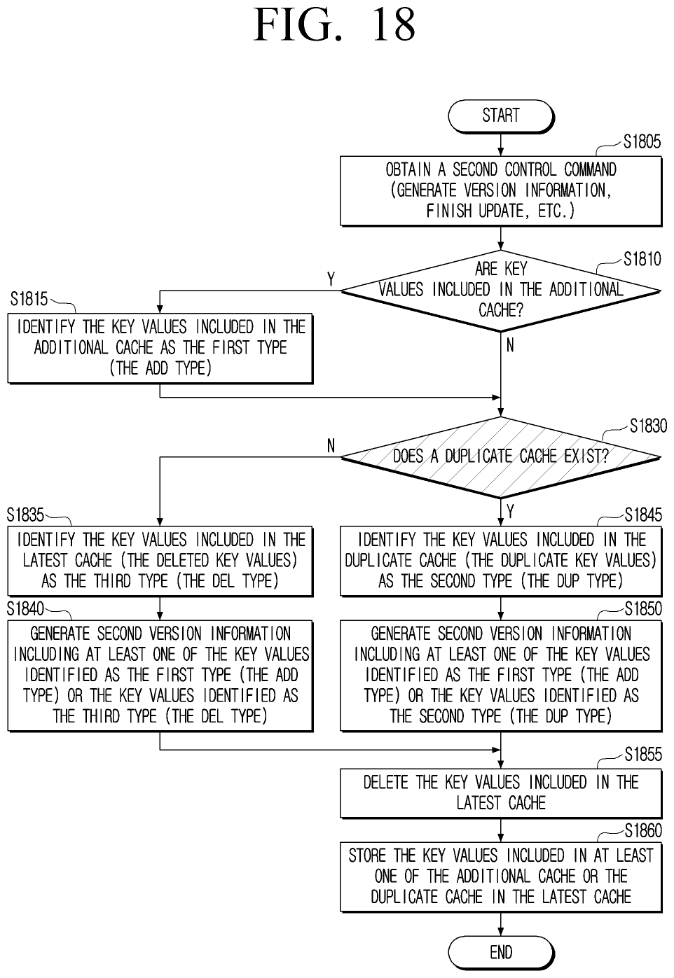

FIG. 18 is a diagram for illustrating an operation of generating version information according to an embodiment of the disclosure.

Referring to FIG. 18, the operations S1805, S1810, S1815, S1835, S1840, S1845, S1850, S1855, and S1860 in FIG. 18 may correspond to the operations S505, S510, S515, S535, S540, S545, S550, S555, and S560 in FIG. 5. Accordingly, overlapping explanation will be omitted.

If key values are not included in the additional cache in operation S1810—N, the electronic apparatus 100 may identify whether a duplicate cache exists in operation S1830. The operation of identifying whether a duplicate cache exists may mean an operation of identifying whether a duplicate cache includes key values.

In case a duplicate cache does not exist in operation S1830—N, the electronic apparatus 100 may perform the operations S1835 and S1840, S1855, and S1860.

In case a duplicate cache exists in operation S1830—Y, the electronic apparatus 100 may perform the operations S1845, S1850, S1855, and S1860.

According to various embodiments of the disclosure, the operations S1805, S1810, S1815, S1830, S1835, and S1845 may be performed by the key value analysis module 60 in FIG. 3. The operations S1840, S1850, S1855, and S1860 may be performed by the address information generation module 70 in FIG. 3.

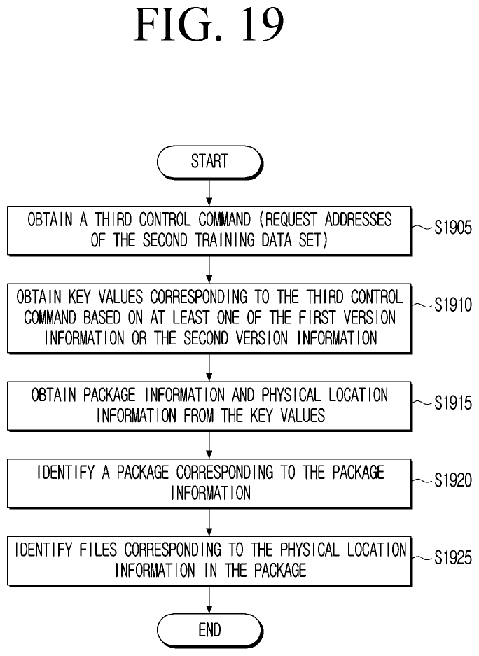

FIG. 19 is a diagram for illustrating an operation of identifying files included in training data according to an embodiment of the disclosure.

Referring to FIG. 19, the electronic apparatus 100 may receive a third control command in operation S1905. The third control command may be a command requesting the addresses of the second training data set.

The electronic apparatus 100 may obtain key values corresponding to the third control command based on at least one of the first version information or the second version information in operation S1910.

The electronic apparatus 100 may obtain package information and physical location information from the key values in operation S1915.

The electronic apparatus 100 may identify a package corresponding to the package information in operation S1920. The electronic apparatus 100 may identify files corresponding to the physical location information in the package in operation S1925.

According to various embodiments of the disclosure, the operations S1905 to S1925 in FIG. 19 may be performed by the key value management module 10.

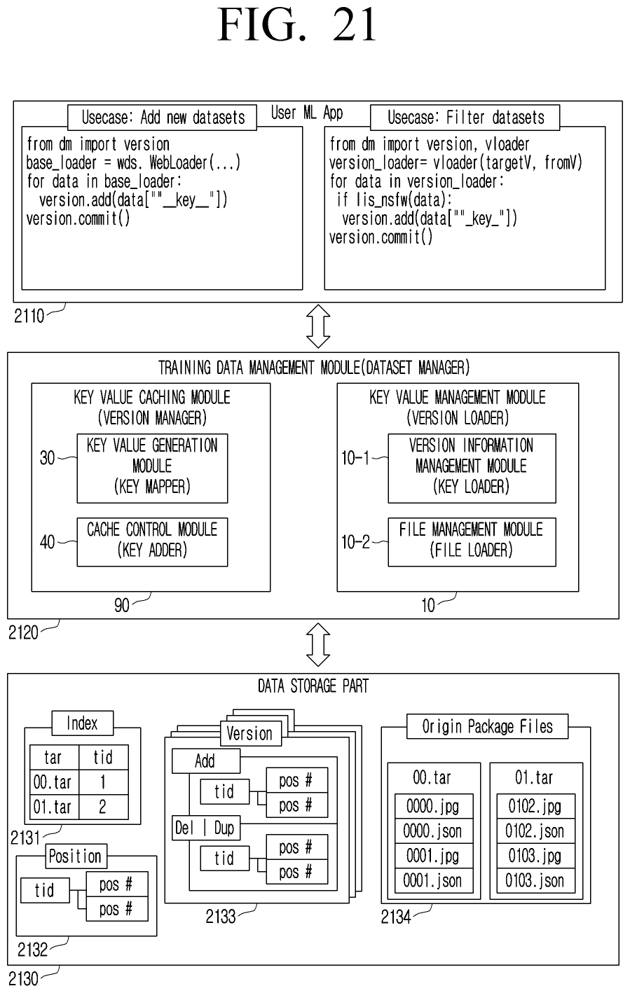

According to various embodiments of the disclosure, the operations S1905 and S1910 in FIG. 19 may be performed by the version information management module 10-1 in FIG. 21.

According to various embodiments of the disclosure, the operations S1905, S1920, and S1930 in FIG. 19 may be performed by the file management module 10-2 in FIG. 21.

FIG. 20 is a diagram for illustrating an operation of comparing key values according to an embodiment of the disclosure.

Referring to FIG. 20, an embodiment 2000 may indicate that an embodiment of comparing the first number and the second number and an operation of comparing the first number and the half of the third number correspond to each other.

The operation S530 in FIG. 5 or the operation S1740 in FIG. 17 of comparing the numbers of key values may be replaced by different operations.

As an example, in the operation S530 in FIG. 5, the first number indicating the key values included in the duplicate cache and the second number of the key values that were not deleted in the latest cache are compared. The comparing operation may be replaced by an operation of comparing the first number indicating the key values included in the duplicate cache and the third number of the key values included in the latest cache.

For example, the operation S525 in FIG. 5 may be replaced by an operation of obtaining the third number of the key values included in the latest cache. The operation S530 in FIG. 5 may be replaced by an operation of identifying whether the first number exceeds the third number*0.5.

As an example, in the operation S1740 in FIG. 17, the first number of the key values included in the duplicate cache and the third number of the key values included in the latest cache are compared. The comparing operation may be replaced by an operation of comparing the first number indicating the key values included in the latest cache and the second number of the key values that were not deleted in the latest cache.

For example, the operation S1710 in FIG. 17 may be replaced by an operation of obtaining the second number of the key values that were not deleted in the latest cache. The operation S1740 in FIG. 17 may be replaced by an operation of identifying whether the second number is smaller than the first number.

Mathematical proof of such a replacing operation is as follows.

The number of the key values stored in the latest cache is assumed as n (the third number).

The number of key values that overlap with the generated key values among the key values stored in the latest cache is assumed as x (the first number).

The number of key values that are not included in the generated key values (the deleted key values) among the key values stored in the latest cache is assumed as y (the second number).

The number of the duplicate key values x may be obtained by subtracting the number of the deleted key values y from the number of the key values stored in the latest cache n. Accordingly, a formula 2010 may indicate that n is a sum of x and y.

A formula 2020 may indicate that the number of the duplicate key values x is bigger than a half (n/2) of the number of the key values of the latest cache (the third number).

If the formula 2010 is substituted into n included in the formula 2020, a formula 2030 may be obtained. If the formula 2030 is modified, a formula 2040 may be obtained.

The formula 2020 and the formula 2040 may be in a corresponding relation. Accordingly, the formula 2040 indicating that the number of the duplicate key values x is bigger than the number of the deleted key values y may be obtained.

Accordingly, an embodiment of comparing the first number and the second number and an operation of comparing the first number and the half of the third number may correspond to each other.

The explanation disclosed in FIGS. 21 to 23 indicates various embodiments for explaining operations related to the artificial intelligence model of the disclosure.

FIG. 21 is a diagram for illustrating an operation of managing training data according to an embodiment of the disclosure.

Referring to FIG. 21, the electronic apparatus 100 may include at least one of a user application 2110, a training data management module 2120, or a data storage part 2130.

The user application 2110 may be a module that requests target training data (or a target file) among training data stored in the data storage part 2130. The user application 2110 may be a module that receives a user's command (or request). The user application 2110 may receive a user input requesting a training data set by using a specific keyword (or key). The user application 2110 may transmit the received user input to the training data management module 2120.

The training data management module 2120 may be a module that performs an operation of managing training data. The training data management module 2120 may provide address information (or key values) corresponding to a user input by using information stored in the data storage part 2130. The training data management module 2120 may be a module that performs various operations regarding key values corresponding to at least one file.

The training data management module 2120 may include at least one of a key value cashing module 90 or the key value management module 10 in FIG. 3.

The key value cashing module 90 may include at least one of the key value generation module 30 or the cache control module 40 in FIG. 3.

The key value management module 10 may include at least one of a version information management module 10-1 or a file management module 10-2.

The version information management module 10-1 may be a module that generates version information. The version information management module 10-1 may be a module that generates version information when an updating operation for training data is performed.

The file management module 10-2 may be a module that generates address information. The file management module 10-2 may be a module that generates address information corresponding to a user input based on at least one piece of version information. The file management module 10-2 may selectively load (or search) only a package corresponding to key values provided by the training data management module 2120 among the plurality of packages included in the original training data set 2134. This is because package information and physical location information are included in the key values.

The data storage part 2130 may be a module that stores various types of data (or information) used in managing training data. The data storage part 2130 may include at least one of package information 2131, physical location information 2132, version information 2133, or original data set information 2134.

The package information 2131 may be information wherein identification information of files (e.g., names) and identification information of a package wherein the files are classified are mapped. The package information 2131 may include information indicating a bidirectional map. The package information 2131 may also be described as index information.

According to various embodiments of the disclosure, the data storage part 2130 may additionally store at least one of the original hash information set 820, and the key value set 830 in FIG. 8, the hash information 920 in FIG. 9, a key value information 930 in FIG. 9, or the cache information disclosed in FIGS. 10 to 14.

According to various embodiments of the disclosure, the data storage part 2130 may be included in the memory 110 of the electronic apparatus 100.

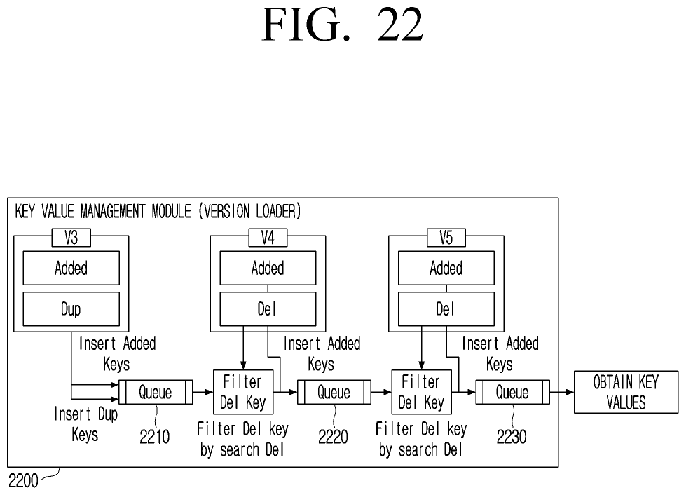

FIG. 22 is a diagram for illustrating an operation of identifying key values of files used in a training process based on the stored version information according to an embodiment of the disclosure.

Referring to FIG. 22, in embodiment 2200, the electronic apparatus 100 may load key values of target files used in a training process through the key value management module 10. The key value management module 10 may have a parallel load component structure based on a queue for parallel streaming load.

The key value management module 10 may manage (or calculate) key values included in the plurality of pieces of version information by using a queue. The key value management module 10 may process (or transmit) key values by generating a queue between version information including a duplicate type and the target version information.

The key value management module 10 may push the key values of the oldest version information V3 to a queue 2210. The key value management module 10 may store the key values included in the previous version information V3 based on the queue 2210.

The key value management module 10 may obtain key values included in the third type (the del type) included in the next version information V4. The key value management module 10 may remove (or filter) the key values included in the third type (the del type) included in the version information V4 from the key values included in the version information V3 stored in the queue 2210. The key value management module 10 may add the remaining key values to a new queue 2220 based on the removal result (the filtering result).

The key value management module 10 may obtain key values included in the third type (the del type) included in the next version information V5. The key value management module 10 may remove (or filter) the key values included in the third type (the del type) included in the version information V5 from the key values included in the version information V4 stored in the queue 2220. The key value management module 10 may add the remaining key values to a new queue 2230 based on the removal result (the filtering result).

The key value management module 10 may obtain key values included in the queue 2230, and generate address information including the obtained key values.

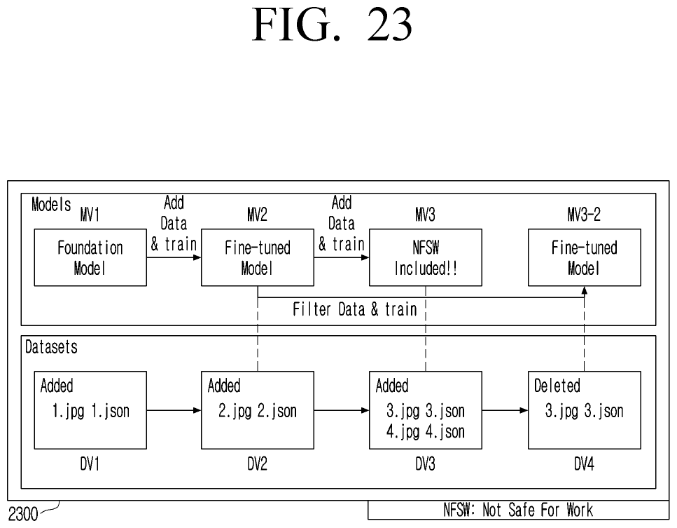

FIG. 23 is a diagram for illustrating a training process of an artificial intelligence model according to an embodiment of the disclosure.

Referring to FIG. 23, an embodiment 2300 may indicate an operation of excluding some training results among a plurality of training processes.

In the first training process, the artificial intelligence model MV1 may be trained by the training data set DV1.

In the second training process, the artificial intelligence model MV2 may be trained by the training data set DV2.

In the third training process, the artificial intelligence model MV3 may be trained by the training data set DV3. It is assumed that a predetermined event occurs in the third training process. The predetermined event may indicate an event wherein data that should not be included is included in the training data. For example, the predetermined event may be a Not Safe For Work (NSFW) event.

In the fourth training process, the electronic apparatus 100 may train the artificial intelligence model MV3-2 with a new training data set DV4 by deleting some files that were used in the third training process.

The electronic apparatus 100 may record version information indicating a use record of the training data in the first training process to the fourth training process.

As the version information can indicate a use history of the training data, it may be helpful in understanding a use flow of the training data easily.

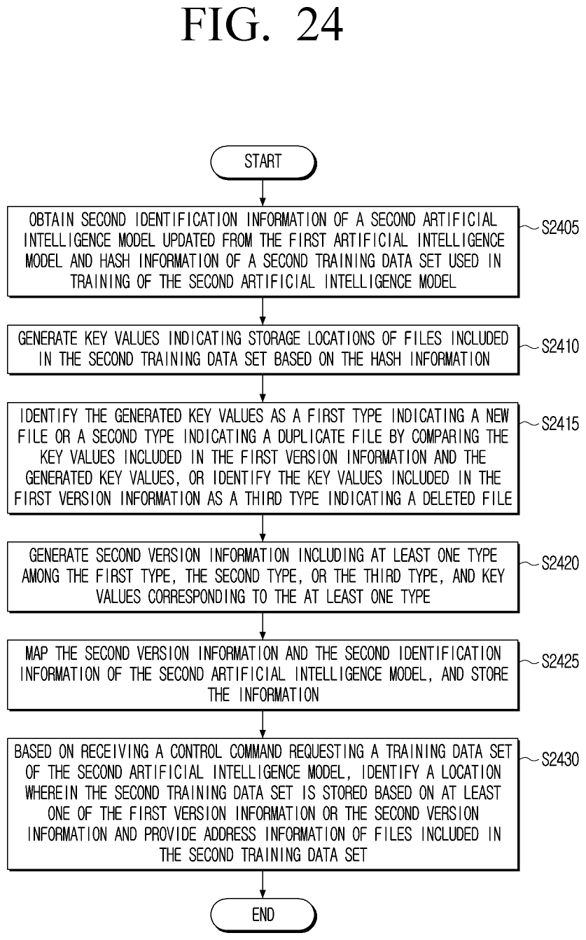

FIG. 24 is a diagram for illustrating a method of controlling the electronic apparatus 100 according to an embodiment of the disclosure.

Referring to FIG. 24, a method of controlling an electronic apparatus that maps first identification information of a first artificial intelligence model and first version information including key values indicating storage locations of files included in a first training data set used in training of the first artificial intelligence model, and stores the information including the operations of obtaining second identification information of a second artificial intelligence model updated from the first artificial intelligence model and hash information of a second training data set used in training of the second artificial intelligence model in operation S2405, generating key values indicating storage locations of files included in the second training data set based on the hash information in operation S2410, identifying the generated key values as a first type indicating a new file or a second type indicating a duplicate file by comparing the key values included in the first version information and the generated key values, or identifying the key values included in the first version information as a third type indicating a deleted file in operation S2415, generating second version information including at least one type among the first type, the second type, or the third type, and key values corresponding to the at least one type in operation S2420, and mapping the second version information and the second identification information of the second artificial intelligence model, and storing the information in the electronic apparatus in operation S2425. In addition, the method includes, based on receiving a control command requesting a training data set of the second artificial intelligence model, identifying a location wherein the second training data set is stored based on at least one of the first version information or the second version information and providing address information of files included in the second training data set in operation S2430.

The method may include, based on the generated key values not being included in a current cache, storing the generated key values in an additional cache, and based on the generated key values being included in the current cache, deleting the generated key values from the latest cache and storing the generated key values in a duplicate cache.

The method may include, based on key values being included in the additional cache, identifying the key values included in the additional cache as the first type.

The method may include obtaining a first number of the key values included in the duplicate cache, obtaining a second number of the key values that were not deleted in the latest cache, and identifying the second type or the third type by comparing the first number and the second number, and in the generating of the second version information in operation S2420, second version information including the key values corresponding to the second type or the third type may be generated.

The first number may indicate the number of files that are included in both of the first training data set and the second training data set, and the second number may indicate the number of files that are included in the first training data set but are not included in the second training data set.

The method may include, based on the second number not being smaller than the first number, identifying the key values included in the duplicate cache as the second type, and in the generating of the second version information in operation S2420, the second version information including the second type and the key values corresponding to the second type may be generated.

The method may include, based on the second number being smaller than the first number, identifying the key values that were not deleted in the latest cache as the third type, and in the generating of the second version information in operation S2420, the second version information including the third type and the key values corresponding to the third type may be generated.

The method may include, based on the second version information being generated, deleting the key values included in the latest cache, and storing the key values included in at least one of the additional cache or the duplicate cache in the latest cache.

The hash information may include at least one of the names of the files included in the second training data set or the hash values of the files included in the second training data set, and in the generating of the key values in operation S2410, the key values of the files included in the second training data set may be generated based on at least one of the names or the hash values.

In the generating of the key values in operation S2410, based on at least one of the names or the hash values, identification information of a data package wherein the files included in the second training data set are included and information on physical locations wherein the files included in the second training data set are stored in the data package may be obtained, and the key values of the files included in the second training data set may be generated by combining the identification information of the data package and the physical location information.

The methods according to the aforementioned various embodiments of the disclosure may be implemented in forms of applications that can be installed on electronic apparatuses of the related art.

In addition, the methods according to the aforementioned various embodiments of the disclosure may be implemented just with software upgrade, or hardware upgrade of electronic apparatuses of the related art.

In addition, the aforementioned various embodiments of the disclosure can be performed through an embedded server provided on an electronic apparatus, or an external server of at least one of an electronic apparatus or a display apparatus.

Further, according to an embodiment of the disclosure, the aforementioned various embodiments may be implemented as software including instructions stored in machine-readable storage media, which can be read by machines (e.g., computers). The machines refer to apparatuses that call instructions stored in a storage medium, and can operate according to the called instructions, and the apparatuses may include an electronic apparatus according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’only means that a storage medium does not include signals, and is tangible, but does not indicate whether data is stored in the storage medium semi-permanently or temporarily.

In addition, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g., compact disc read only memory (CD-ROM)), or distributed on-line through an application store. In the case of on-line distribution, at least a portion of a computer program product may be stored in a storage medium, such as the server of the manufacturer, the server of the application store, and the memory of the relay server at least temporarily, or may be generated temporarily.

In addition, each of the components according to the aforementioned various embodiments (e.g., a module or a program) may consist of a singular object or a plurality of objects, and among the aforementioned corresponding sub components, some sub components may be omitted, or other sub components may be further included in the various embodiments. Alternatively or additionally, some components (e.g., a module or a program) may be integrated as an object, and perform functions that were performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
memory storing one or more computer programs and configured to map first identification information of a first artificial intelligence model and first version information including key values indicating storage locations of files included in a first training data set used in training of the first artificial intelligence model, and store the information; and
one or more processors communicatively coupled to the memory,
wherein the one or more computer programs include computer-executable instructions that, when executed by the one or more processors individually or collectively, cause the electronic apparatus to:
obtain second identification information of a second artificial intelligence model updated from the first artificial intelligence model and hash information of a second training data set used in training of the second artificial intelligence model,
generate key values indicating storage locations of files included in the second training data set based on the hash information,
identify the generated key values as a first type indicating a new file or a second type indicating a duplicate file by comparing the key values included in the first version information and the generated key values, or identify the key values included in the first version information as a third type indicating a deleted file,
generate second version information including at least one type among the first type, the second type, or the third type, and key values corresponding to the at least one type,
map the second version information and the second identification information of the second artificial intelligence model, and store the information in the memory,
based on receiving a control command requesting a training data set of the second artificial intelligence model, identify a location wherein the second training data set is stored based on at least one of the first version information or the second version information, and
provide address information of files included in the second training data set.

2. The electronic apparatus of claim 1, wherein the one or more computer programs further include computer-executable instructions that, when executed by the one or more processors individually or collectively, cause the electronic apparatus to:
based on the generated key values not being included in a current cache, store the generated key values in an additional cache, and
based on the generated key values being included in the current cache, delete the generated key values from the latest cache and store the generated key values in a duplicate cache.

3. The electronic apparatus of claim 2, wherein the one or more computer programs further include computer-executable instructions that, when executed by the one or more processors individually or collectively, cause the electronic apparatus to:
based on key values being included in the additional cache, identify the key values included in the additional cache as the first type.

4. The electronic apparatus of claim 2, wherein the one or more computer programs further include computer-executable instructions that, when executed by the one or more processors individually or collectively, cause the electronic apparatus to:
obtain a first number of the key values included in the duplicate cache,
obtain a second number of the key values that were not deleted in the latest cache,
identify the second type or the third type by comparing the first number and the second number, and
generate the second version information including the key values corresponding to the second type or the third type.

5. The electronic apparatus of claim 4,
wherein the first number indicates a number of files that are included in both of the first training data set and the second training data set, and
wherein the second number indicates the number of files that are included in the first training data set but are not included in the second training data set.

6. The electronic apparatus of claim 4, wherein the one or more computer programs further include computer-executable instructions that, when executed by the one or more processors individually or collectively, cause the electronic apparatus to:
based on the second number not being smaller than the first number, identify the key values included in the duplicate cache as the second type, and
generate the second version information including the second type and the key values corresponding to the second type.

7. The electronic apparatus of claim 4, wherein the one or more computer programs further include computer-executable instructions that, when executed by the one or more processors individually or collectively, cause the electronic apparatus to:
based on the second number being smaller than the first number, identify the key values that were not deleted in the latest cache as the third type, and
generate the second version information including the third type and the key values corresponding to the third type.

8. The electronic apparatus of claim 4, wherein the one or more computer programs further include computer-executable instructions that, when executed by the one or more processors individually or collectively, cause the electronic apparatus to:
based on the second version information being generated, delete the key values included in the latest cache, and
store the key values included in at least one of the additional cache or the duplicate cache in the latest cache.

9. The electronic apparatus of claim 1,
wherein the hash information comprises:
at least one of names of the files included in the second training data set or hash values of the files included in the second training data set, and
wherein the one or more computer programs further include computer-executable instructions that, when executed by the one or more processors individually or collectively, cause the electronic apparatus to:
generate the key values of the files included in the second training data set based on at least one of the names or the hash values.

10. The electronic apparatus of claim 9, wherein the one or more computer programs further include computer-executable instructions that, when executed by the one or more processors individually or collectively, cause the electronic apparatus to:
based on at least one of the names or the hash values, obtain identification information of a data package wherein the files included in the second training data set are included and information on physical locations wherein the files included in the second training data set are stored in the data package, and
generate the key values of the files included in the second training data set by combining the identification information of the data package and the physical location information.

11. A method of controlling an electronic apparatus, the method comprising:
mapping first identification information of a first artificial intelligence model, and first version information including key values indicating storage locations of files included in a first training data set used in training of the first artificial intelligence model, and storing the information;
obtaining second identification information of a second artificial intelligence model updated from the first artificial intelligence model and hash information of a second training data set used in training of the second artificial intelligence model;
generating key values indicating storage locations of files included in the second training data set based on the hash information;
identifying the generated key values as a first type indicating a new file or a second type indicating a duplicate file by comparing the key values included in the first version information and the generated key values, or identifying the key values included in the first version information as a third type indicating a deleted file;
generating second version information including at least one type among the first type, the second type, or the third type, and key values corresponding to the at least one type;
mapping the second version information and the second identification information of the second artificial intelligence model, and storing the information in the electronic apparatus;
based on receiving a control command requesting a training data set of the second artificial intelligence model, identifying a location wherein the second training data set is stored based on at least one of the first version information or the second version information; and
providing address information of files included in the second training data set.

12. The method of claim 11, further comprising:
based on the generated key values not being included in a current cache, storing the generated key values in an additional cache; and
based on the generated key values being included in the current cache, deleting the generated key values from the latest cache and storing the generated key values in a duplicate cache.

13. The method of claim 12, further comprising:
based on key values being included in the additional cache, identifying the key values included in the additional cache as the first type.

14. The method of claim 12, further comprising:
obtaining a first number of the key values included in the duplicate cache,
obtaining a second number of the key values that were not deleted in the latest cache, and
identifying the second type or the third type by comparing the first number and the second number, and
wherein the generating the second version information comprises:
generating the second version information including the key values corresponding to the second type or the third type.

15. The method of claim 14,
wherein the first number indicates a number of files that are included in both of the first training data set and the second training data set, and
wherein the second number indicates the number of files that are included in the first training data set but are not included in the second training data set.

16. The method of claim 14, further comprising:
based on the second number not being smaller than the first number, identifying the key values included in the duplicate cache as the second type; and
generating the second version information including the second type and the key values corresponding to the second type.

17. The method of claim 14, further comprising:
based on the second number being smaller than the first number, identifying the key values that were not deleted in the latest cache as the third type; and
generating the second version information including the third type and the key values corresponding to the third type.

18. The method of claim 14, further comprising:
based on the second version information being generated, deleting the key values included in the latest cache; and
storing the key values included in at least one of the additional cache or the duplicate cache in the latest cache.

19. One or more non-transitory computer-readable storage media storing computer-executable instructions that, when executed by one or more processors individually or collectively, cause an electronic apparatus to perform operations, the operations comprising:
mapping first identification information of a first artificial intelligence model, and first version information including key values indicating storage locations of files included in a first training data set used in training of the first artificial intelligence model, and storing the information;
obtaining second identification information of a second artificial intelligence model updated from the first artificial intelligence model and hash information of a second training data set used in training of the second artificial intelligence model;
generating key values indicating storage locations of files included in the second training data set based on the hash information;
identifying the generated key values as a first type indicating a new file or a second type indicating a duplicate file by comparing the key values included in the first version information and the generated key values, or identifying the key values included in the first version information as a third type indicating a deleted file;
generating second version information including at least one type among the first type, the second type, or the third type, and key values corresponding to the at least one type;
mapping the second version information and the second identification information of the second artificial intelligence model, and storing the information in the electronic apparatus;
based on receiving a control command requesting a training data set of the second artificial intelligence model, identifying a location wherein the second training data set is stored based on at least one of the first version information or the second version information; and
providing address information of files included in the second training data set.

20. The one or more non-transitory computer-readable storage media of claim 19, the operations further comprising:
based on the generated key values not being included in a current cache, storing the generated key values in an additional cache; and
based on the generated key values being included in the current cache, deleting the generated key values from the latest cache and storing the generated key values in a duplicate cache.
